(19) United States
(12) Patent Application Publication
(10) Pub. No.: US 2011/0106807 A1
(43) Pub. Date: May 5, 2011

(54) SYSTEMS AND METHODS FOR INFORMATION INTEGRATION THROUGH CONTEXT-BASED ENTITY DISAMBIGUATION

(75) Inventors: Rohini K. Srihari, Williamsville, NY (US); Harish Srinivasan, North Tonawanda, NY (US); Richard Smith, Grand Island, NY (US); John Chen, Buffalo, NY (US)

(73) Assignee: JANYA, INC, Washington, DC (US)

(21) Appl. No.: 12/917,384

(22) Filed: Nov. 1, 2010

Related U.S. Application Data
(60) Provisional application No. 61/256,781, filed on Oct. 30, 2009.

(51) Int. Cl. G06F 17/30

(52) U.S. Cl. 707/739; 707/E17.046

(57) ABSTRACT

Described within are systems and methods for disambiguating entities, by generating entity profiles and extracting information from multiple documents to generate a set of entity profiles, determining equivalence within the set of entity profiles using similarity matching algorithms, and integrating the information in the correlated entity profiles. Additionally, described within are systems and methods for representing entities in a document in a Resource Description Framework and leveraging the features to determine the similarity between a plurality of entities. An entity may include a person, place, location, or other entity type.

### PRIORITY CLAIM

This application claims to the benefit of U.S. Provisional Patent Application No. 61/256,781, filed Oct. 30, 2009, the content of which is incorporated herein by reference in its entirety.

### TECHNICAL FIELD

The Systems and Methods for Information Integration Through Context-Based Entity Disambiguation relates generally to natural language document processing and analysis. More specifically, various embodiments relate to systems and methods for entity disambiguation to resolve co-referential entity mentions in multiple documents.

### BACKGROUND

Natural language processing systems are computer implemented software systems that intelligently derive meaning and context from natural language text. “Natural languages” are languages that are spoken by humans (e.g., English, French and Japanese). Computers cannot, without assistance, distinguish linguistic characteristics of natural language text. Natural language processing systems are employed in a wide range of products, including Information Extraction (IE) engines, spelling and grammar checkers, machine translation systems, and speech synthesis programs.

Often, natural languages contain ambiguities that are difficult to resolve using computer automated techniques. Word disambiguation is necessary because many words in any natural language have more than one meaning or sense. For example, the English noun “sentence” has two senses in common usage: one relating to grammar, where a sentence is a part of a text or speech, and one relating to punishment, where a sentence is a punishment imposed for a crime. Human beings use the context in which the word appears and their general knowledge of the world to determine which sense is meant.

With the growing size and generality of electronic document corpus, the need to identify and extract important concepts in a corpus of electronic documents is commonly acknowledged by those skilled in the art, to be a necessary first step towards achieving a reduction in the ever-increasing volumes of electronic documents in the corpus.

There are several challenging aspects to the identification of names: identifying the text strings (words or phrases) that express names; relating names to the entities discussed in the document; and relating named entities across documents. In relating names to entities, the main difficulty is the many-to-many mapping between them. A single entity can be referred to by several name variants: FORD MOTOR COMPANY, FORD MOTOR CO., or simply FORD. A single variant often names several entities: Ford refers to the car company, but also to a place (Ford, Mich.) as well as to several people: President Gerald Ford, Senator Wendell Ford, and others. Context is crucial in identifying the intended mapping. A document usually defines a single context, in which it is quite unlikely to find several entities corresponding to the same variant. For example, if the document talks about the car company, it is unlikely to also discuss Gerald Ford. Thus, within documents, the problem is usually reduced to a many-to-one mapping between several variants and a single entity. In the few cases where multiple entities in the document may potentially share a name variant, the problem is addressed by careful editors, who refrain from using ambiguous variants. If Henry Ford, for example, is mentioned in the context of the car company, he will most likely be referred to by the unambiguous Mr. Ford.

Much recent work has been devoted to the identification of names within documents and to linking names to entities within the document. Several research groups, as well as a few commercial software packages, have developed name identification technology. In a collection of documents, there are multiple contexts; variants may or may not refer to the same entity; and ambiguity is a much greater problem. Cross-document coreference has been briefly considered as a task by others but then discarded as being too difficult.

The task of entity name disambiguation has received attention only in the last decade. For example, recently, others have proposed a method for determining whether two names (mostly of people) or events refer to the same entity by measuring the similarity between the documents contexts in which they appear. This approach compares every two names which share a substring in common, for example, “President Clinton” and “Clinton, Ohio,” to determine whether they refer to the same entity. This approach suffers from a potentially n-squared number of comparisons, which is a very costly process and cannot scale to process the size of current, and most certainly future, document collections. In addition, this approach does not address another cross-document problem of names that are potentially combinations of two or more names, which should be separated into their components, such as “President Clinton of the United States.”

In another example, others have employed unsupervised learning approaches, such as representing the named-entity disambiguation as a graph problem and constructing a social network graph to learn the similarity matrix.

In a further example, still others have employed a combination of lexical context features and information extraction results and obtained superior performance over conventional results. These approaches use the following features in a Vector Space Model (VSM)—(i) Summary terms: Each non-stop word appearing within a fixed window around any mention of the entity, (ii) Base Noun Phrases (BNP): All tokens (unit of words/phrase in the document as processed by an IE engine) that are non-recursive noun phrases in the sentences containing the ambiguous name (or a coreference) and (iii) Document Entities (DE): All tokens that are named entities (Person other than the ambiguous name, Organization name, Location etc. as well as their nominals) in the entire document.

To date, VSM Systems addressing unsupervised cross-document disambiguation have used approaches, such as the Bag of Words approach, and the B-cubed F-measure scoring system and unsupervised learning approaches. These VSM Systems have been extremely constrained in the types of linguistic information they can learn. For example, convention systems automatically learn how to disambiguate entities by either name matching techniques that picks up variations in spelling, transliteration schemes, etc. or simple context similarity checking by looking for keyword overlaps in the fields of a record. Additionally, the above systems are based on keyword similarities and are not sophisticated enough to deal with cases where sparse information is available, or the individuals are using an alias. Thus, the convention systems above are more focused on matching names, and less focused on entity disambiguation, i.e., whether content describing two people with the same name, actually refers to the same person.

Therefore, a need exists for an entity coreference resolution system and method that can be applied across a plurality of the electronic documents in a corpus.

### SUMMARY OF THE INVENTION

In embodiments of Systems and Methods for Information Integration Through Context-Based Entity Disambiguation (“Entity Disambiguation System”) includes within-document or cross-document entity disambiguation techniques that extend, enhance and/or improve the characteristics of VSM Systems, such as the F-measure, using topic model features and Entity Profiles, Another embodiment of Systems and Methods for Information Integration Through Entity Disambiguation include extending, enhancing and/or improving within-document or cross-document entity disambiguation techniques using the Resource Description Framework (RDF) along with unstructured context.

Additionally, the Entity Disambiguation System includes providing a query independent ranking algorithm for electronic documents, such as electronic search results generated from querying public and/or private documents in a corpus, using the weight of the information context within an entity profile to determine the ranking of the electronic documents.

Embodiments include a system for detecting similarities between entities in a plurality of electronic documents. One system includes instructions for executing a method stored in a storage medium and executed by at least one processor capable of performing at least the following steps of: extracting data for the at least two entities from the plurality of electronic documents, wherein the at least two entities comprise a first entity and a second entity; generating at least one entity profile with a plurality of features for the first entity; generating at least one entity with a plurality of features for the second entity; representing the plurality of features of the first entity as a plurality of vectors in a vector space model; representing the plurality of features of the second entity as a plurality of vectors in a vector space model; determining weights for each of the features the first entity and the second entity, the weights calculated from a term frequency-inverse document frequency value with a cosine similarity Log-transformed measure by the following equation or an equations comprising the following equation:

$$Sim ( {S}_{1} , {S}_{2} ) = {\sum }_{{commontermst}_{j}} {w}_{1 j} \times {w}_{2 j} , \\ where {w}_{ij} = \frac{ln ( tf \times ln \frac{N}{df} )}{\sqrt{{s}_{i 1}^{2} + {s}_{i 2}^{2} + … + {s}_{in}^{2}}}$$

where S₁ and S₂ are vectors for the first entity and the second entity for which the weights are to be calculated; tⱼ is the first entity or the second entity, tf is the frequency of the first entity or the second entity tⱼ in the vector, N is the total number of the plurality of electronic documents, df is the number of the plurality of electronic documents that the first entity or the second entity tⱼ occurs in, denominator is the cosine normalization; determining a final similarity value from the weights; and combining the entities into clusters based on the final similarity value.

Optionally, the two entities may be a person, place, event, location, expression, concept or combinations thereof. In one alternative, features of the first entity and features of the second entity includes summary terms, base noun phrases and document entities. Optionally, the entity profiles are features of an entity, relations, and events that the entity is involved in as a participant in the electronic documents. In one alternative, the vector space model includes a separate bag of words model for a feature in the one entity profile. In another alternative, the single bag of words includes morphological features appended to the single bag of words model. Optionally, the morphological features may be topic model features, name as a stop word, or prefix matched term frequency and combinations thereof. In one alternative, the topic model features includes selecting ten top words. The top ten words have a joint probability that is the highest as compared to other ten word combinations. In another alternative, determining a final similarity value includes averaging the weights for the features of the first entity and the features of the second entity. Optionally, the average may be a plain average, neural network weighting or maximum entropy weighting or combinations thereof.

Embodiments of the Entity Disambigutation System include, a computer based method for detecting similarities between entities in a plurality of electronic documents. The method capable of performing at least the following steps of: extracting data for the at least two entities from the plurality of electronic documents, wherein the at least two entities comprise a first entity and a second entity; generating at least one entity profile with a plurality of features for the first entity; generating at least one entity with a plurality of features for the second entity;

representing the plurality of features of the first entity as a plurality of vectors in a vector space model; representing the plurality of features of the second entity as a plurality of vectors in a vector space model; determining weights for each of the features the first entity and the second entity, the weights calculated from a term frequency-inverse document frequency value with a cosine similarity Log-transformed measure by the following equation or an equations comprising the following equation:

$$Sim ( {S}_{1} , {S}_{2} ) = {\sum }_{{commontermst}_{j}} {w}_{1 j} \times {w}_{2 j} , \\ where {w}_{ij} = \frac{ln ( tf \times ln \frac{N}{df} )}{\sqrt{{s}_{i 1}^{2} + {s}_{i 2}^{2} + … + {s}_{in}^{2}}}$$

where S₁ and S₂ are vectors for the first entity and the second entity for which the weights are to be calculated; tⱼ is the first entity or the second entity, tf is the frequency of the first entity or the second entity tⱼ in the vector, N is the total number of the plurality of electronic documents, df is the number of the plurality of electronic documents that the first entity or the second entity tⱼ occurs in, denominator is the cosine normalization; determining a final similarity value from the weights; and combining the entities into clusters based on the final similarity value.

Optionally, the two entities are may be a person, place, event, location, expression, concept or combinations thereof. In one alternative, features of the first entity and features of the second entity include summary terms, base noun phrases and document entities. In another alternative, the entity profiles include features of an entity, relations, and events that the entity is involved in as a participant in the electronic documents. Alternatively, the vector space model includes a separate bag of words model for a feature in the one entity profile. Optionally, the single bag of words includes morphological features appended to the single bag of words model. Alternatively, the morphological features may be a topic model features, name as a stop word, and prefix matched term frequency or combinations thereof. In one alternative, the topic model features includes selecting ten top words. The top ten words have a joint probability that is the highest as compared to other ten word combinations. In another alternative, determining a final similarity value includes averaging the weights for the features of the first entity and the features of the second entity. Optionally, the average may be plain average, neural network weighting or maximum entropy weighting or combinations thereof.

Embodiments of the Entity Disambigutation System include a system for detecting similarities between entities in a plurality of electronic documents. The system comprises instructions for executing a method stored in a storage medium and executed by at least one processor capable of performing at least the following steps of: extracting data for the at least two entities from the plurality of electronic documents, wherein the at least two entities comprise a first entity and a second entity; generating at least one entity profile with a plurality of features for the first entity; generating at least one entity with a plurality of features for the second entity; representing the first entity as a node on a form factor graph; representing the second entity as a node on a form factor graph; selecting cliques for the first entity node and the second entity node; determining the probability of coreference between the first entity and the cliques; and combining the entities into clusters based on the probability of coreference.

Optionally, the two entities may be a person, place, event, location, expression, concept or combinations thereof. In one alternative, the form factor graph is a resource description framework graph. Alternatively, selecting cliques includes selection of ten neighbors for the first entity node and the second entity node which have the highest MaxEnt probability values as compared to other neighbors. In another alternative, one of the ten neighbors for the first entity node includes the second entity node. Optionally, one of the ten neighbors for the second entity node includes the first entity node. Alternatively, the probability of coreference is calculated with a conditional random field model.

Embodiments of the Entity Disambiguation System include, a computer based method for detecting similarities between entities in a plurality of electronic documents. The method capable of performing at least the following steps of: extracting data for the at least two entities from the plurality of electronic documents, wherein the at least two entities comprise a first entity and a second entity; generating at least one entity profile with a plurality of features for the first entity; generating at least one entity with a plurality of features for the second entity; representing the first entity as a node on a form factor graph; representing the second entity as a node on a form factor graph; selecting cliques for the first entity node and the second entity node; determining the probability of coreference between the first entity and the cliques; and combining the entities into clusters based on the probability of coreference.

Optionally, the two entities may be a person, place, event, location, expression, concept or combinations thereof. Alternatively, the form factor graph is a resource description framework graph. In one alternative, selecting cliques includes selection of ten neighbors for the first entity node and the second entity node which have the highest MaxEnt probability values as compared to other neighbors. In another alternative, one of the ten neighbors for the first entity node includes the second entity node. Optionally, one of the ten neighbors for the second entity node includes the first entity node. In one alternative, the probability of coreference is calculated with a conditional random field model.

Embodiments of the Entity Disambiguation System include a system for ranking a plurality of electronic documents. The system includes instructions for executing a method stored in a storage medium and executed by at least one processor capable of performing at least the following steps of: generating at least one entity profile for an entity with a plurality of features from the extracted data; representing the at least one entity profile as a plurality of vectors in a vector space model; determining weights for the at least one entity profile, the weights calculated by a calculated from a term frequency-inverse document frequency value with a cosine similarity Log-transformed measure; and ranking the electronic documents based on the weights.

Optionally, the entities may be a person, place, event, location, expression, concept or combinations thereof. Alternatively, the features include summary terms, base noun phrases and document entities. In one alternative, the entity profiles include features of an entity, relations, and events that the entity is involved in as a participant in the electronic documents. In another alternative, the vector space model comprises a separate bag of words model for a feature in the entity profile. Optionally, the single bag of words includes morphological features appended to the single bag of words model. Alternatively, the morphological may be a topic model features, name as a stop word, and prefix matched term frequency or combinations thereof. In one alternative, the topic model features includes selecting ten top words. The top ten words have a joint probability that is the highest as compared to other ten word combinations. In another alternative, the electronic documents include web sites, search engines, news feeds, blogs, transcribed audio, legacy text corpuses, surveys, database records, e-mails, translated text (FBIS), technical documents, transcribed audio, classified HUMINT documents, USMTF, XML, other structured or unstructured data from commercial content providers and combinations thereof. Alternatively, the languages comprise English, Chinese, Arabic, Urdu, and Russian and combinations thereof. Optionally, the entity profiles include features of an entity, relations, and events that the entity is involved in as a participant in the electronic documents.

Embodiments of the Entity Disambiguation System may include, a computer based method for detecting similarities between entities in a plurality of electronic documents. The method capable of performing at least the following steps of: generating at least one entity profile for an entity with a plurality of features from the extracted data; representing the at least one entity profile as a plurality of vectors in a vector space model; determining weights for the at least one entity profile, weights calculated by a calculated from a term frequency-inverse document frequency value with a cosine similarity Log-transformed measure; and ranking the electronic documents based on the weights.

Optionally, the entities are selected may be a person, place, event, location, expression, concept or combinations thereof. Alternatively, the features include summary terms, base noun phrases and document entities. In one alternative, the entity profiles include features of an entity, relations, and events that the entity is involved in as a participant in the electronic documents. In another alternative, the vector space model includes a separate bag of words model for a feature in the entity profile. Alternatively, the single bag of words includes morphological features appended to the single bag of words model. Optionally, the morphological features may be a topic model features, name as a stop word, and prefix matched term frequency or combinations thereof. Alternatively, the topic model features includes selecting ten top words. The top ten words have a joint probability that is the highest as compared to other ten word combinations. In another alternative, the electronic documents include web sites, search engines, news feeds, blogs, transcribed audio, legacy text corpuses, surveys, database records, e-mails, translated text (FBIS), technical documents, transcribed audio, classified HUMINT documents, USMTF, XML, other structured or unstructured data from commercial content providers and combinations thereof. Alternatively, the languages include English, Chinese, Arabic, Urdu, and Russian and combinations thereof.

Additional features, advantages, and embodiments of the Entity Disambiguation System are set forth or apparent from consideration of the following detailed description, drawings and claims. Moreover, it is to be understood that both the foregoing summary of the invention and the following detailed description are exemplary and intended to provide further explanation without limiting the scope of the Entity Disambiguation System as claimed.

### BRIEF DESCRIPTION OF THE DRAWINGS

The accompanying drawings, which are included to provide a further understanding of the Entity Disambiguation System and are incorporated in and constitute a part of this specification, illustrate embodiments of the Entity Disambiguation System and together with the detailed description serve to explain the principles of the System. In the drawings:

FIG. 1A-D are illustrative examples of name disambiguation, with different entities often having the same name;

FIG. 2 is a flowchart illustrating a series of operations used for cross-document co-reference resolution in multiple documents in an alternative embodiment of an Entity Disambiguation System;

FIG. 3 is a schematic depiction of the internal architecture of an information extraction engine according to one embodiment of a Entity Disambiguation System;

FIG. 4 is a flowchart illustrating a series of operations used for cross-document co-reference resolution in multiple documents in an alternative embodiment of an Entity Disambiguation System;

FIG. 5 is an illustrative example of a document level entity profile with attribute value (two tuple) pairs according to one embodiment of an Entity Disambiguation System;

FIG. 6 is an illustrative example of two document level entity profiles that may be merged according to one embodiment of an Entity Disambiguation System;

FIG. 7A-C are an illustrative example of the features contained within a document-level entity profile according to one embodiment of an Entity Disambiguation System;

FIG. 8 is a flowchart illustrating a series of operations used for within-document entity co-reference resolution with the Resource Description Framework (RDF) according to one embodiment of an Entity Disambiguation System;

FIG. 9 is an illustrative example of a Conditional Random Field graph for within-document entity co-reference resolution according to one embodiment of an Entity Disambiguation System;

FIG. 10 is a flowchart illustrating a series of operations used for cross-document entity co-reference resolution with the RDF according to one embodiment of an Entity Disambiguation System;

FIG. 11 is a flowchart illustrating a series of operations used to rank electronic documents in a corpus using a query independent ranking algorithm in one embodiment of an Entity Disambiguation System;

FIG. 12 is an illustrative example of a cross-document entity profile according to one embodiment of an Entity Disambiguation System;

FIG. 13 is an illustrative example of a portion of the entity profile extracted for the character of Mary Crawford in chapter 7 of Mansfield Park according to one embodiment of an Entity Disambiguation System; and

FIG. 14 is an illustrative example of an entity profile generated according to one embodiment of an Entity Disambiguation System.

### DETAILED DESCRIPTION

In the following detailed description of the illustrative embodiments, reference is made to the accompanying drawings that form a part hereof. These embodiments are described in sufficient detail to enable those skilled in the art to practice an Entity Disambiguation System and related systems and methods, and it is understood that other embodiments may be utilized and that logical structural, mechanical, electrical, and chemical changes may be made without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

As will be appreciated by one of skill in the art, aspects of an Entity Disambiguation System and related systems and methods may be embodied as a method, data processing system, or computer program product. Accordingly, aspects of an Entity Disambiguation System and related systems and methods may take the form of an entirely hardware embodiment or an embodiment combining software and hardware aspects, all generally referred to herein as an information extraction engine. Furthermore, elements of an Entity Disambiguation System and related systems and methods may take the form of a computer program product on a computer-usable storage medium having computer-usable program code embodied in the medium. Any suitable computer readable medium may be utilized, including hard disks, CD-ROMs, optical storage devices, flash RAM, transmission media such as those supporting the Internet or an intranet, or magnetic storage devices.

Computer program code for carrying out operations of an Entity Disambiguation System and related systems and methods may be written in an object oriented programming language such as Java®, Smalltalk or C++ or others. Computer program for code carrying out operations of an Entity Disambiguation System and related systems and methods may be written in conventional procedural programming languages, such as the “C” programming language or other programming languages. The program code may execute entirely on the server, partly on the server, as a stand-alone software package, partly on the server and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider) using any network or internet protocol, including but not limited to TCP/IP, HTTP, HTTPS, SOAP.

Aspects of an Entity Disambiguation and related systems and methods are described with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, server, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer, server or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks, and may operate alone or in conjunction with additional hardware apparatus described herein.

As used herein, an entity can represent a person, place, event, or concept or other entity types.

As used herein, a database can be a relational database, flat file database, relational database management system, object database management system, operational database, data warehouse, hyper media database, post-relational database, hybrid database models, RDF databases, key value database, XML database, XML store, a text file, a flat file or other type of database.

An entity profile reflects a consolidation of important information pertaining to an entity within a document. In one embodiment, for a person the entity profile includes all mentions of the individual, including co-referential mentions, as well as relationship and events involving the person. An entity profile, when compiled from a collection of documents, is rich in information that provides the required context in which to compare two individuals, classify human behavior, etc. Some have found that Entity profiles are more accurate than using context computed by taking a window of words surrounding the entity mention. Automatically extracting Entity profiles (and associated text snippets) is a challenging task in information extraction.

Information integration, also known as information fusion, deduplication and referential integrity, is the merging of information from disparate sources with differing conceptual, contextual and typographical representations. It is used in data mining and consolidation of data from unstructured or semi-structured resources. For example, a user may want to compile baseball statistics about Hideki Matsui from multiple electronic sources, in which he may be referred to as Hideki Matsui or Godzilla in each of the sources, as people sometimes use different aliases when expressing their opinions about an entity.

Cross-document coreference occurs when the same entity is discussed in more than one document. Computer recognition of this phenomenon is important because it helps break “the document boundary” by allowing a user to examine information about a particular entity from multiple documents at the same time. In particular, resolving cross-document coreferences allows a user to identify trends and dependencies across documents. Cross-document coreference can also be used as the central tool for producing summaries from multiple documents, and for information integration or fusion, both of which are advanced areas of research.

Cross-document coreference also differs in substantial ways from within-document coreference. Within a document there is a certain amount of consistency which cannot be expected across documents. In addition, the problems encountered during within document coreference are compounded when looking for coreferences across documents because the underlying principles of linguistics and discourse context no longer apply across documents. Because the underlying assumptions in cross-document coreference are so distinct, they require novel approaches.

Information retrieval, to improve recall of a web search on a person's name, a search engine can automatically expand the query using aliases of the name. For example, a user who searches for Hideki Matsui might also be interested in retrieving documents in which Matsui is referred to as Godzilla. By aggregating information written about an individual that uses various aliases, a sentiment analysis system may make an informed judgment on the sentiment.

In another example, a GOOGLE search for the name, “Jim Clark”, provides results in which the name “Jim Clark” may refer to the formula-one racing champion, or the founder of Netscape, amongst several other individuals named Jim Clark. Although namesakes have identical names, their nicknames usually differ. Therefore, a name disambiguation algorithm can benefit from the knowledge related to name aliases.

In another example, a GOOGLE search for “George Bush” on multiple search engines may return documents in which “George Bush” may refer either to President George H. W. Bush or President George W. Bush. If we wish to use a search engine to find documents about one of them, we are likely also to find documents about the other. Improving our ability to find all documents referring to one and not referring to the other in a targeted search is a goal of cross-document entity coreference resolution.

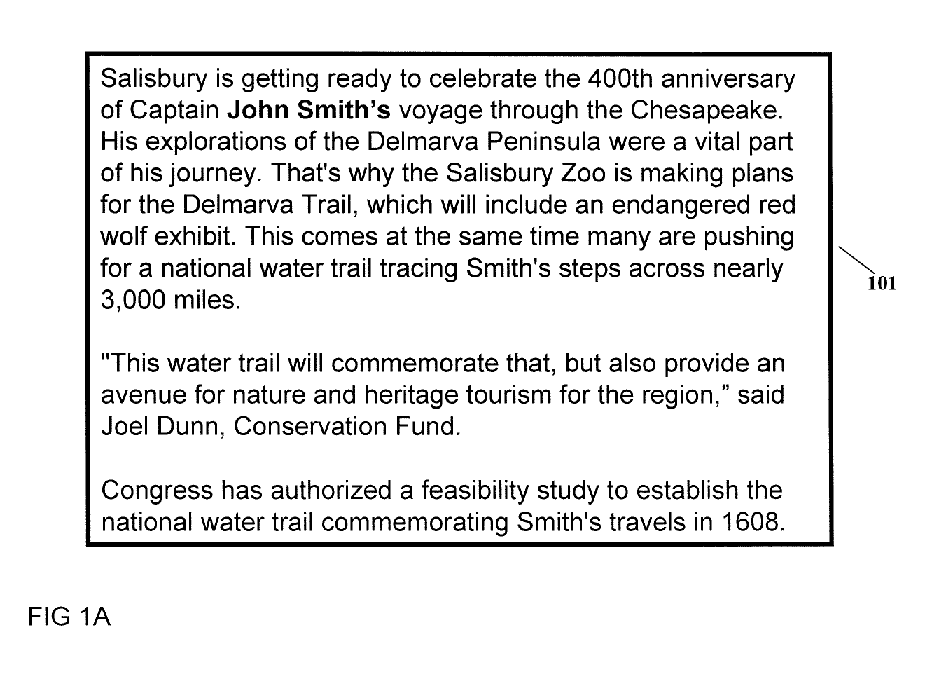

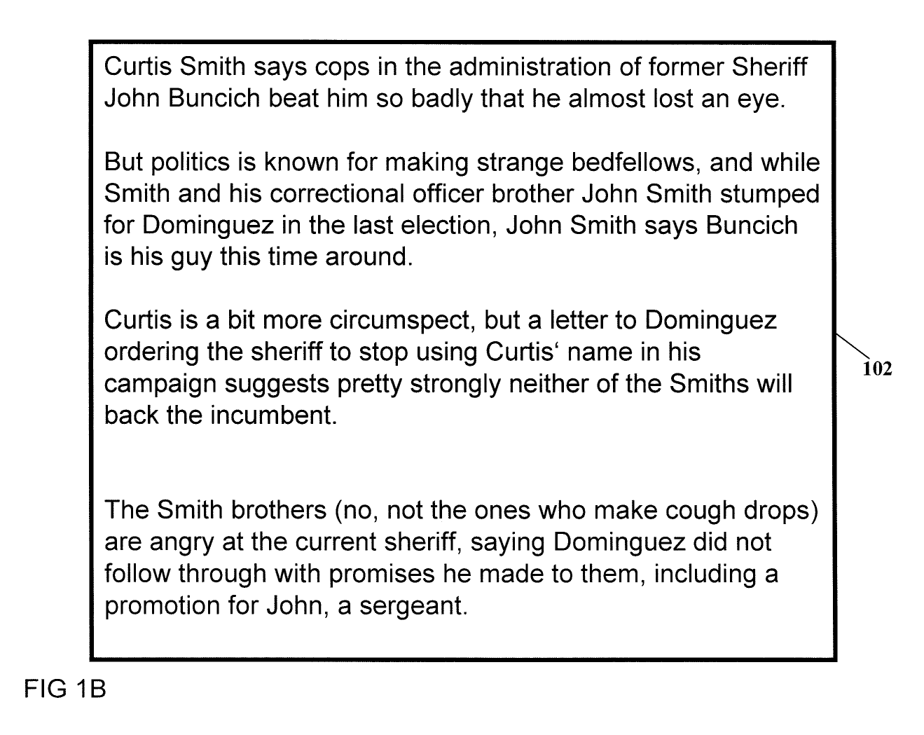

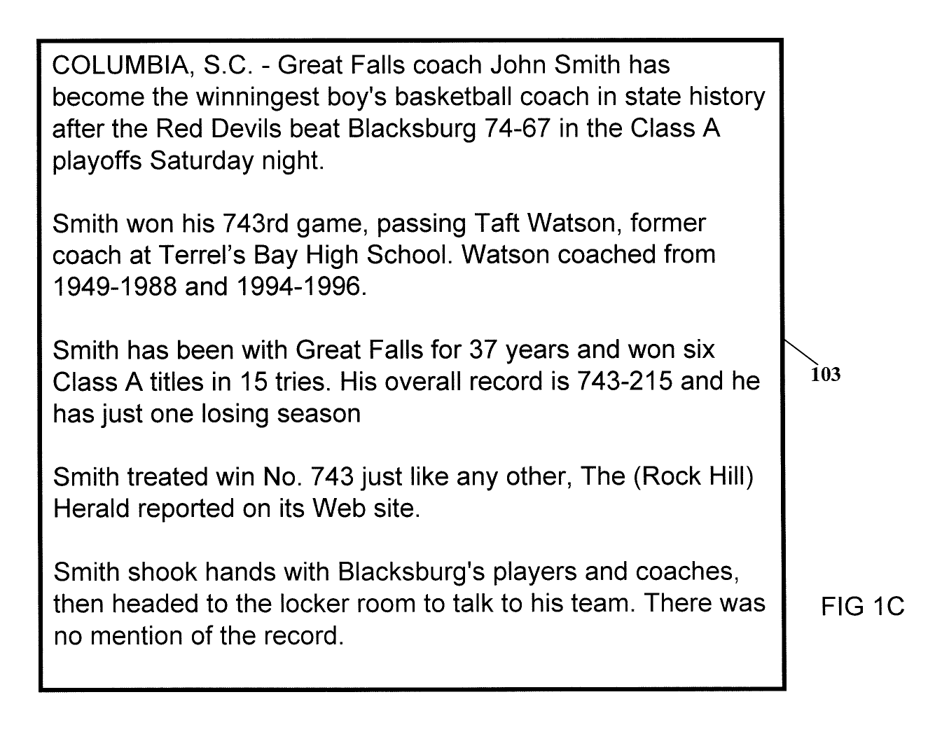

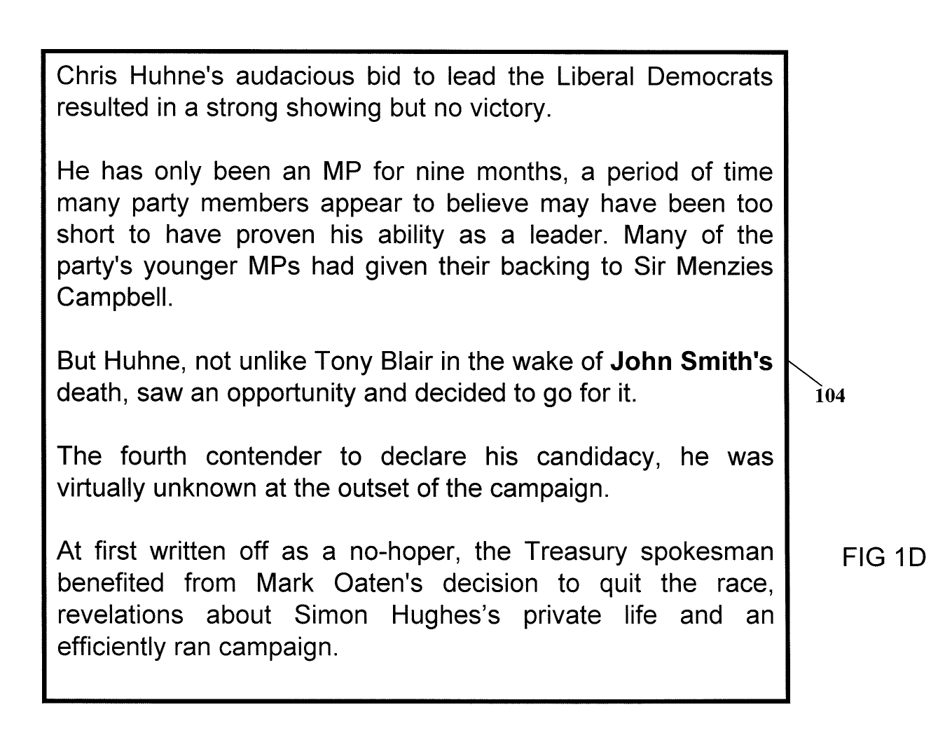

Name disambiguation focuses on identifying different individuals with the same name. Given a corpus and an ambiguous entity name, embodiments of an Entity Disambiguation System facilitate the clustering of documents such that each cluster contains all and only those documents that correspond to the same entity. For example, as illustrated in FIGS. 1A-D a query for the name “John Smith” in a corpus results in several different documents with references to the name “John Smith,” where “John Smith” may refer to Captain John Smith and his voyage through the Chesapeake about 400 years ago 101, John Smith, the Great Falls coach in Columbia, S.C. 103, John Smith, a correctional officer 104 or John Smith, a member of parliament in the United Kingdom 102.

Generating an Entity Profile

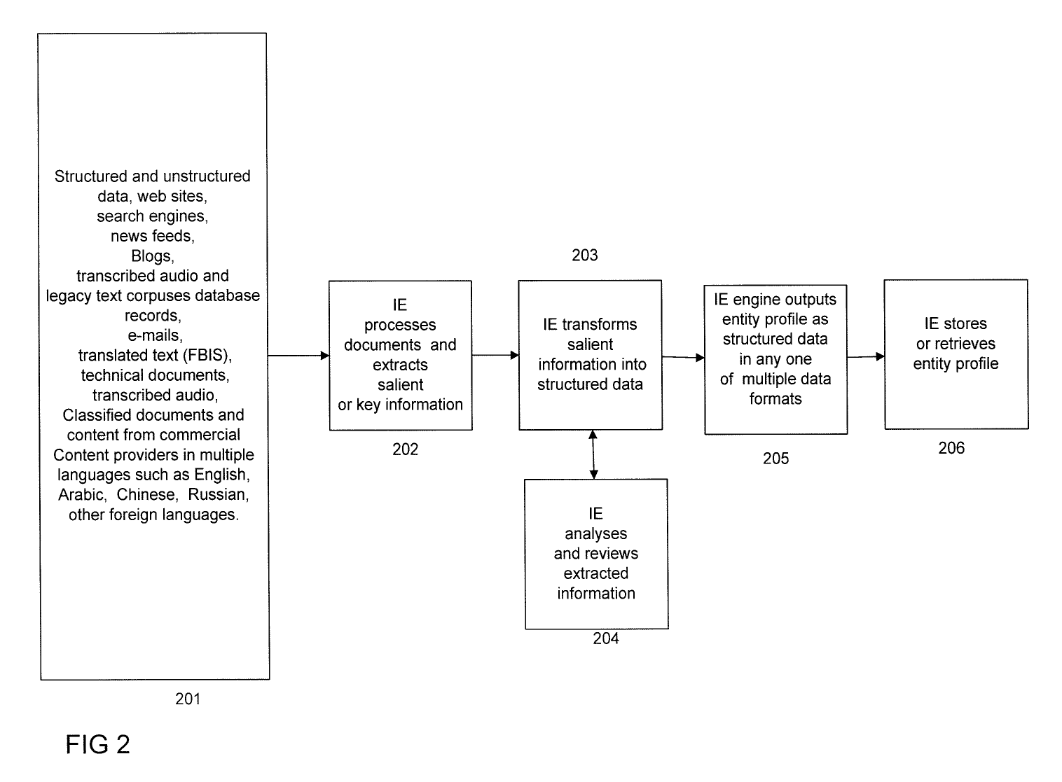

Referring now to FIG. 2, there is shown a flowchart illustrating a series of operations, according to embodiments of an Entity Disambiguation System that is used to generate an entity profile 308 for each unique entity in one or more documents. In some alternatives, as illustrated in FIG. 17, an entity profile 308 is a summary of the entity 1401 that combines in one place features of the entity 1401, attributes of the entity 1401, relations to or from another entity 1401, and events that the entity 1401 is involved in as a participant. For example, the entity profile 308 may contain an organization profile 1405, person profile 1402, 1403 and a location profile 1404. At step 201, a set of electronic documents, which may be in multiple languages, are received from multiple sources. In step 202 the electronic documents are processed by software 309 to recognize named entity and nominal entity mentions 301 using maximum entropy markov models (“MaxEnt”). In step 203 the processed data from step 202 is transformed into structured data by using techniques, such as tagging salient or key information from the entity 1401 with Extensible Markup Language (XML) tags. In step 204, software 309 performs a coreference resolution on the nominal entity mentions 301 as well as any pronouns in the document according to a pairwise entity coreference resolution module. In step 205, software 309 outputs the entity profile 308 structured data into any one of multiple data formats. In step 206 the software 309 stores the entity profile 308 in a database.

Information Extraction (IE) Engine

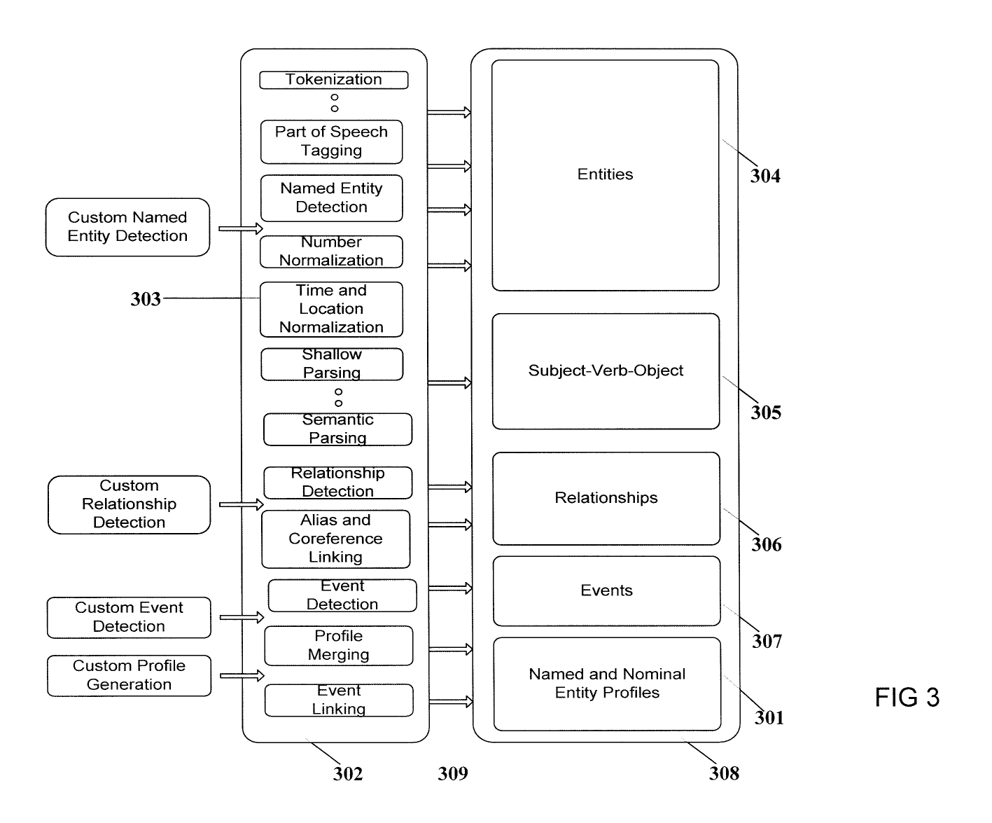

In one alternative, the processes of FIG. 2 are implemented by a platform or engine such as the IE engine software 309 depicted in FIG. 3. In FIG. 3 there is shown a system architecture of an IE engine in accordance with one embodiment.

In one embodiment, computer program 309 is a breed of natural language processing (NLP) systems that tag salient or key information about entities in a document or text file, and transforms the information such that it may be populated into a database: The information in the database is used subsequently used to drive various analytics applications. The software 309 natural linguistic processor modules 302 may support different levels of natural language processing, including orthography, morphology, syntax, co-reference resolution, semantics, and discourse.

The categories of information objects (representing salient information in an entity) created by the software 309 may be (i) Named Entities (NE) 304 such as, proper names of persons, organizations, product, location etc.; (ii) Relationships 306 such as, local relationships (e.g. spouse, employed-by) between entities within sentence boundaries; (iii) Subject-Verb-Object triples (“SVO”) 305 such as, SVO 305 triples decoded by the software 309 may be logical rather than syntactic: surface variations such as active voice vs. passive voice are decoded into the same underlying logical relationships; (iv) General Events 307 such as, verb-centric information objects representing “who did what to whom when and where;” and (v) entity profiles 308 which may be complex rich information objects that collect entity-centric information.

Entities or Named Entities 304 may be people, places, events, concepts or other entity types with proper names, nicknames, tradenames, trademarks and the like such as George Bush, Janya and Buffalo. The software 309 consolidates mentions and attributes of these entities 304 across a document, including pronouns and nominal entities 301. Nominal Entities 301 are entities unnamed in the text but with vital descriptions or known information that may be associated only through these generic terms such as “the company.”

Relationships 306 may be links between two entities 304 or an entity and one of its attributes. In one embodiment, the Entity Disambiguation System provides a pre-defined core set of relationships 306 that may be of interest to most users, such as personal (for example, spouse or parent), contact information (for example, address or phone) and organizational (for example, employee or founder). Optionally, relationships 306 are also be customized to a particular domain or user specification.

Events 307 provide a set of pre-defined events 307 over multiple domains, such as terrorism and finance. In addition, the Entity Disambiguation System may consider all semantically rich verb forms as events 307 and outputs the corresponding Subject-Verb-Object-Complement (SVOC) 305 structure accordingly. In some embodiments, the Entity Disambiguation System consolidates these events with time and location normalization 303.

Entity profiles 308 may create a single repository of all extracted information about an entity contained within a single document. Entity mentions 301 may be names, nominals (the tall man), or pronouns. Entity profiles 308 may contain any descriptions and attributes of an entity from the text including age, position, contact info and related entities and events. An example of an Entity profile 308 corresponding to a person, may include one or more mentions of that person, including aliases and anaphoric resolutions, for example, Mary Crawford, Mary, she, Miss Crawford; descriptive phrases associated with the person, for example, ‘wearing a red hat’; events that the person is involved in, for example, ‘attending a party’; relationships that the person is part of, for example, ‘his sister’; quotes involving the person, i.e. what others are saying about this person; and quotes that are attributed to this person, i.e., what they say.

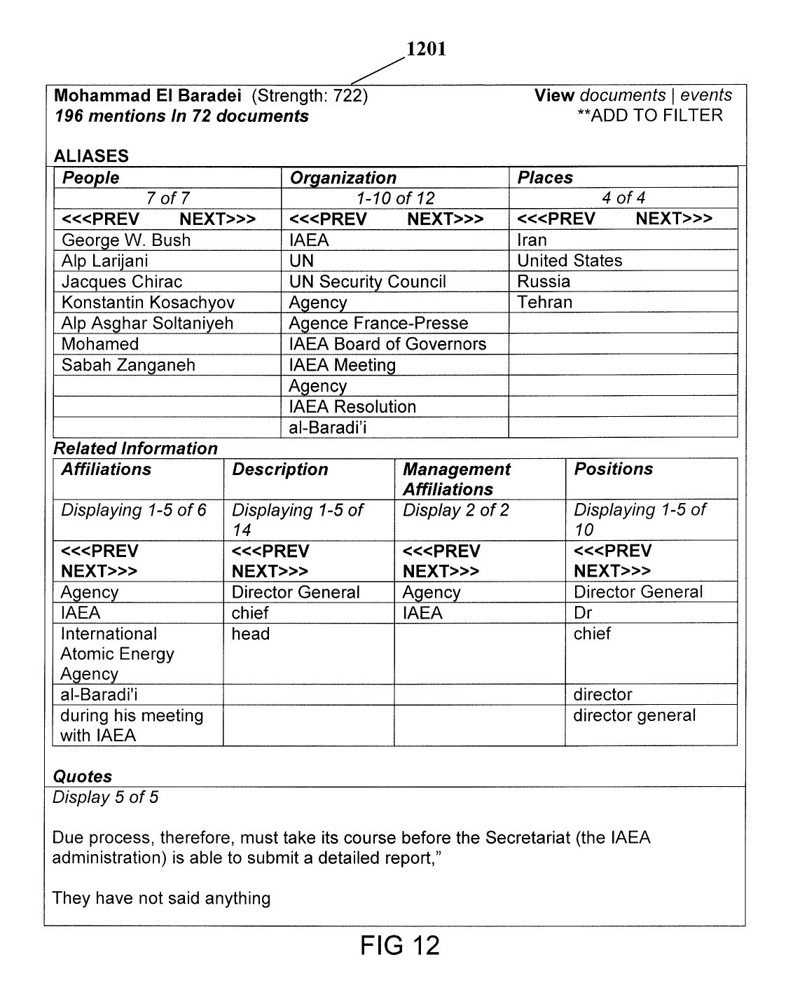

In some alternatives, the software 309 uses a hybrid extraction model combining statistical, lexical, and grammatical model in a single pipeline of processing modules and using advantageous characteristics of each. When a document is processed by the software 309, the results is data with XML tags that reflect the information that has been extracted, including the entity profiles 308. This data is typically populated in a database. FIG. 5 illustrates an example of an entity profile generated by the software 309 using embodiments of the Entity Disambiguation System. FIG. 5 illustrates an example of the attributes and values for a document level entity profile 308 generated by the software 309 using embodiments of the Entity Disambiguation System. FIG. 12 illustrates a cross-document entity profile generated by the software 309 with the strength 1201 of the entity profile displayed. The strength of the entity profile is a user (or administrator) defined parameter for an entity profile that may contain values, such as the weight of the information context of the entity profile derived from a similarity matching algorithm. As used herein, a similarity matching algorithm may be a single similarity matching algorithm, multiple similarity matching algorithms or a hybrid similarity matching algorithm derived from multiple similarity matching algorithms.

In some alternatives, the entity profile 308 generates a pseudo document consisting of sentences from which the various elements of an entity profile 308 have been extracted. These sentences may or may not be contiguous due to coreferential mentions. These set of sentences may be used as context by the software 309 for computing sentiment.

In some alternatives, the results of the software 309 processing includes entities 304, relationships 306, and events 307 as well as syntactic information including base noun phrases 704 and syntactic and semantic dependencies. Named entity 304 and nominal entity mentions 301 are recognized using any suitable model, such as MaxEnt models. The entity profile 308 may contain an attribute for the name of the entity, such as PRF_NAME, for which the entity profile 308 may have been generated; however, this attribute may not be used when performing any actions based on the context of the entity profile 308.

In some alternatives, the software 309 processes electronic documents in Unicode (UTF-8) text or process multilingual documents from languages such as, Chinese (simplified), Arabic, Urdu, and Russian. This may occur with changes to only the lexicons, grammars, language models, and with no changes to the software 309 platform. The software 309 may also process English text with foreign words that use special characters, such as the umlaut in German and accents in French.

In some alternatives, the software 309 processes information from several sources of unstructured or semi-structured data such as web sites, search engines, news feeds, blogs, transcribed audio, legacy text corpuses, surveys, database records, e-mails, translated text, Foreign Broadcast Information Service (FBIS), technical documents, transcribed audio, classified HUMan INTelligence (HUMINT) documents, United States Message Text Format (USMTF), XML records, and other data from commercial content providers such as FACTIVA and LEXIS-NEXIS.

In some alternatives, the software 309 outputs the entity profile 308 data in one or more formats, such as XML, application-specific formats, proprietary and open source database management systems for use by Business Intelligence applications, or directly feed visualization tools such as WebTAS or VisuaLinks, and other analytics or reporting applications.

In some alternatives, the software 309 is integrated with other Information Extraction systems that provide entity profiles 308 with the characteristics of those generated by the software 309.

In some alternatives, the entity profiles 308 generated by the software 309 is used for semantic analysis, e-discovery, integrating military and intelligence agencies information, processing and integrating information for law enforcement, customer service and CRM applications, context aware search, enterprise content management and semantic analysis. For example, the entity profiles 308 may provide support or integrate with military or intelligence agency applications; may assist law enforcement professionals with exploiting voluminous information available by processing documents, such as crime reports, interaction logs, news reports among others that are generally know to those skilled in the art, and generate entity profiles 308, relationships 306 and enable link analysis and visualization; may aid corporate and marketing decision making by integrating with a customer's existing Information Technology (IT) infrastructure setup to access context from external electronic sources, such as the web, bulletin boards, blogs and news feeds among others that are generally know to those skilled in the art; may provide a competitive edge through comprehensive entity profiling, spelling correction, link analysis, and sentiment analysis to professionals in fields, such as digital forensics, legal discovery, and life sciences research areas; may provide search application with context-awareness, thereby improving conventional search results with entity profiling, multilingual extraction, and augmentation of machine translation; and may provide control over an enterprise's data sources, thereby powering content management, and extending data utilization beyond the traditional structured data

In some alternatives, the software 309 processes documents 1102 one at a time. Alternatively, the software 309 processes multiple documents simultaneously.

Topic Model Features and Entity Profiles

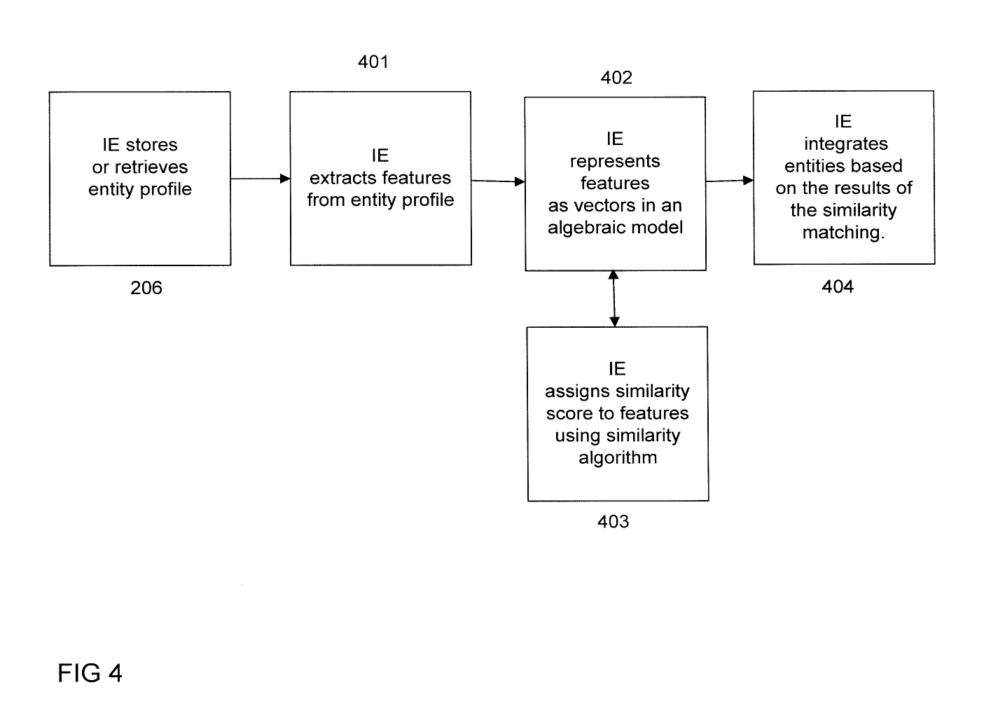

FIG. 4 is a flowchart illustrating a series of operations, according to embodiments of the Entity Disambiguation System that may be used to integrate information from multiple electronic documents. The process of FIG. 4 is preferably implemented by means of the software 309 or other embodiments described herein. At Step 206, the software 309 retrieves entity profiles 308 generated in FIG. 2. In step 401, the software 309 extracts the features of the entity profiles 308 and stores them as attribute-value 501 (two tuple) pairs as illustrated in FIG. 5. In step 402, the features are represented as one or more vectors in a VSM. In step 403, the software 309 uses the one or more vectors from step 402 and assigns multiple similarity scores to the one or more vectors based on vector similarity and using a similarity matching algorithm. In some alternatives, the similarity matching algorithm may contain a hybrid similarity matching algorithm derived from multiple matching similarity algorithms that act upon one or more features of the vector. Finally, in step 404 the software 309 based on thresholds, or other criteria established by a user, integrates or merges the information in the entity profiles 308 based on the results of the similarity matching algorithms.

In some alternatives, the following features are extracted from the entity profiles 308 generated from a document 101, summary 701, base noun phrases (BNP) 704, document entities (DE) 705, profile features (PF) 703 and Summary term 702 features. Optionally, summary 701 features refer to all sentences which contain a reference to the ambiguous entity, including coreference sentences (nominal and pro-nominal). BNP 704 may include non recursive noun phrases in sentence where the entity is mentioned. DE 705 may include named entities 304 and nominals 301 of organizations, vehicles, weapons, location and person other than ambiguous names, brand names, product names, scientific concept names, gene names, disease names, sports team name or other types of document entities.

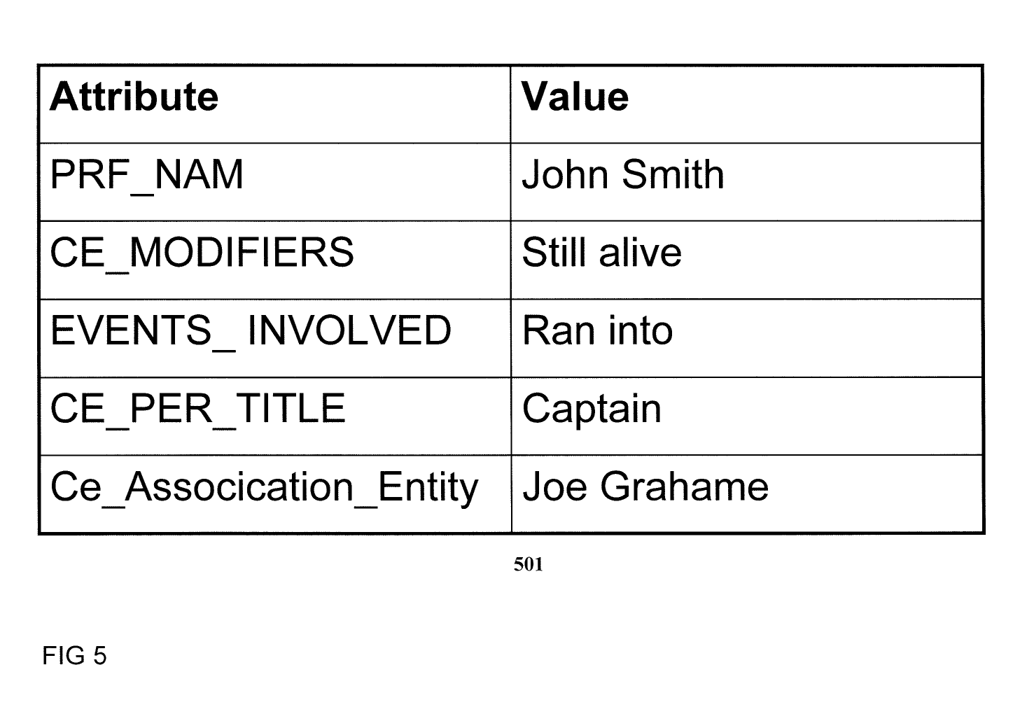

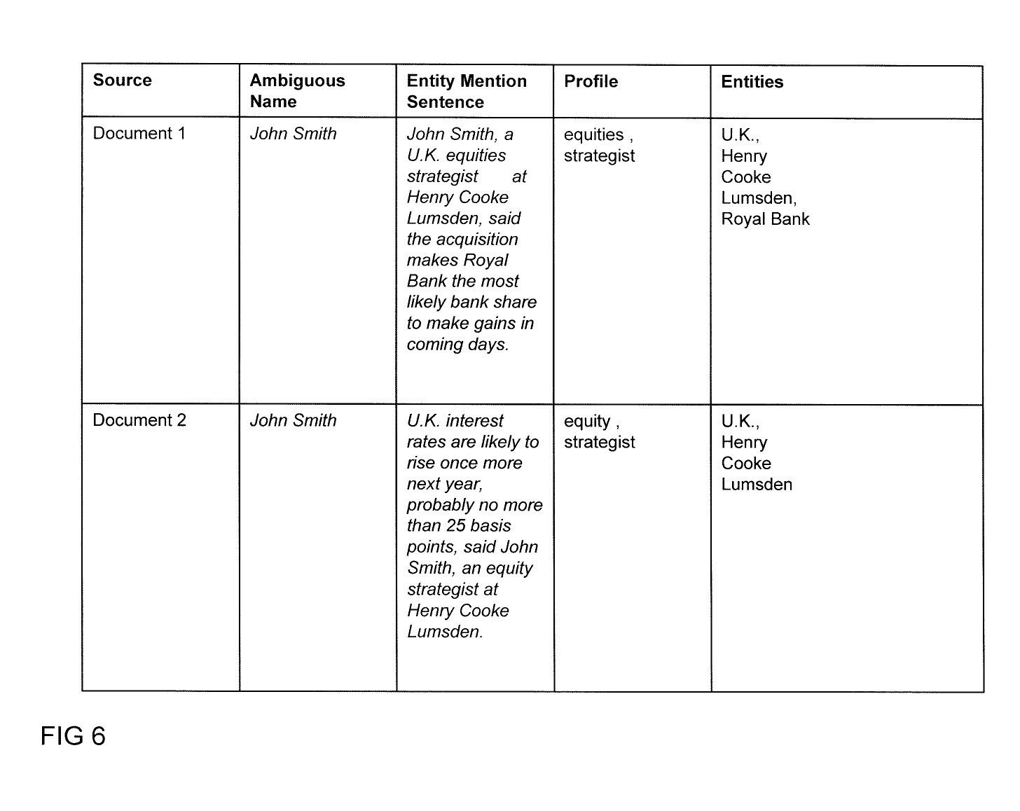

In concept, this embodiment utilizes a model known as an entity disambiguation model, in which a bag of words and phrases are obtained from features. The term frequency-inverse document frequency (TF-IDF) value is computed with a cosine similarity Log-transformed measure, with prefix match used for term frequency and the ambiguous entity name used as a stop word. A VSM is populated with the features and a Hierarchical agglomerative clustering within single linkage is run across the vectors representing the documents. FIG. 6 illustrates an example of two documents to be merged by the software 309 using embodiments of the Entity Disambiguation System.

In some alternatives, a VSM is employed to represent the document level entities 304. The VSM considers the words (terms) in a given document as a ‘bag of words.’ Systems using the VSM employ separate ‘bag of words’ for each of the three features (Summary 701 terms 702, BNP 704 and DE 705) and uses a Soft TF-IDF weighting scheme with cosine similarity to evaluate the similarity between two entities. The similarities computed from each feature may be averaged to obtain a final similarity value.

In some alternatives, conventional uses of the VSM with a Single bag of words model, PF, topic model features (TM), name as a stop word (Nsw), prefix matched term frequency (Ptf), TF-IDF weighting and hierarchical agglomerative clustering is modified.

In some alternatives, a single bag of words model is employed, rather than the separate bag of words used in conventional VSM systems to allow terms from one bag of words (summary sentence terms) to match the terms from another bag of words (DE-document entities).

In some alternatives, all of the features in entity profile 308 are extracted and stored as attribute value (“two tuple”) pairs as illustrated in the value term in the tuple may then be appended to the ‘bag of phrases and words. FIG. 5 illustrates an example of the attributes and values for a document level entity profile 308 generated by the software 309 using embodiments of the Entity Disambiguation System. Because they are extracted from the same input document, there will often be overlap between profile features 703 and features of other types. For example, in the input sentence “Captain John Smith first beheld American strawberries in Virginia.” Here, the feature “Captain” may be both a Summary 701 term 702 and a profile feature 703. Still, profile features 703 are useful because they highlight critical entity information. In this example, “Captain” is highlighted because it is a person title. In contrast, “strawberries” would be a Summary 701 term 702 feature but not a profile feature 703.

In some alternatives, certain pairs of documents may have no common terms in their feature space even though, they contained similar terms such as ‘island, bay, water, ship’ in one document and ‘founder, voyage, and captain’ in another document. A naive string matching (VSM model) fails to match these terms. Hence, an expansion of the common noun words in a document may have been attempted using topic modeling. Every document may be assigned a possible set of topics and every topic may be associated with a list of most common words. The number of topics to learn was set at fifty. The top ten words with highest joint probability of word in topic and topic in a document are chosen (morphological features) and appended to the existing bag of words and phrases. This may be represented by the following equation: P(w,t|D)=P(w|t, D)×P(t|D)=P(w|t)×P(t|D) where w, t and D are word, topic and document respectively.

In some alternatives, the ambiguous entity name in question may have been included in the stop word list. This may be intuitive since the name itself provides no information in resolving the ambiguity as it may be present in one or more of the documents.

In some alternatives, when calculating the term frequency of a particular term in a document, a Ptf match is used. For example, if the term was ‘captain’, and even if only ‘capt’ was present in the document, it is counted towards the term frequency. This modification may allow for the possibility of correctly matching commonly used abbreviated words with the corresponding non-abbreviated words.

The TF-IDF formulation as used in conventional VSM systems can be depicted in the equation below:

$$Sim ( {S}_{1} , {S}_{2} ) = {\sum }_{{commontermst}_{j}} {w}_{1 j} \times {w}_{2 j} , \\ where {w}_{ij} = \frac{tf \times ln \frac{N}{df}}{\sqrt{{s}_{i 1}^{2} + {s}_{i 2}^{2} + … + {s}_{in}^{2}}}$$

where S₁ and S₂ may be the term vectors for which the similarity may be computed. TF may be the frequency of the term tⱼ in the vector. N may be the total number of documents. IDF may be the number of documents in the collection that the term tⱼ occurs in. The denominator may be the cosine normalization. The Entity Disambiguation System modifies the TF-IDF formulation as used in conventional VSM systems as depicted in the equation below:

$$Sim ( {S}_{1} , {S}_{2} ) = {\sum }_{{commontermst}_{j}} {w}_{1 j} \times {w}_{2 j} , \\ where {w}_{ij} = \frac{ln ( tf \times ln \frac{N}{df} )}{\sqrt{{s}_{i 1}^{2} + {s}_{i 2}^{2} + … + {s}_{in}^{2}}}$$

These weights wᵢⱼ may then be used to calculate the similarity values between document pairs. In error analysis it was observed that, several document pairs had low similarity values despite belonging to the same cluster. If one were to use a threshold to decide on the decision to merge clusters, the log transformation may have had no effect, because the transformation may be a monotonic function. In the case of hierarchical agglomerative clustering using single linkage, this transformation may help alleviate the problem by relatively better spacing out those ambiguous document pairs with low similarity scores.

In another alternative, the Entity Disambiguation System can be used as a stand alone (without any use of Knowledge Base (KB)) to cluster the entities present in a corpus such that each cluster consists of unique entities. Using the above mentioned features and the modified TF-IDF weighting scheme the cosine-similarity is applied to obtain a “# of documents by # of documents” similarity matrix. A hierarchical agglomerative clustering algorithm using single linkage across vectors representing documents to disambiguate an entity name or to cluster the similarity matrix and group documents that mention the same name. An optomized stop threshold for clustering is then used to compare the clustering results using B-Cubed F-Measure against the key for that corpus. An example of an optimized stop threshold is defined to be that threshold value where the number of clusters obtained using hierarchical clustering is the same as the number of unique individuals for that given corpus. Typically, in a real world corpus, this information is not known and hence an optimized threshold cannot be found directly. In this scenario, the Entity Disambguation System uses an annotated data set to learn this threshold and then uses it towards all future clustering.

For example, given a corpus and an ambiguous name (say ‘John Smith’) to cluster the corpus such that each cluster contains mentions of a unique individual. Two sets of corpora were used for performing experimental evaluations—(i) a corpus containing one ambiguous name and (ii) English boulder name corpora containing four sub corpus each corresponding to four different ambiguous names. These together gave a total of five different corpus each one containing a ambiguous name. Table 1 summarizes the characteristics of each of the five different corpora

TABLE 1

| | Ambiguous Name | | | | |
|---|---|---|---|---|---|
| | John | James | John | Michael | Robert |
| | Smith | Jones | Smith | Johnson | Smith |
| Corpus | Bagga | English | English | English | English |
| | Baldwin | Boulder | Boulder | Boulder | Boulder |
| Total No of | 197 | 104 | 112 | 101 | 100 |
| Documents | | | | | |
| No of | 35 | 24 | 54 | 52 | 65 |
| Clusters | | | | | |
| (Unique | | | | | |
| Names) | | | | | |

Using the basic VSM model and with no additional features or enhancements, Table 2 compares the results obtained by the Entity Disambiguation System with that reported by conventional systems. The difference in the performance between the VSM systems using the same VSM model may be due to the difference in the software 309 used and the list of stop words

TABLE 2

| | John | | John | | | |
|---|---|---|---|---|---|---|
| | Smith | James | Smith | Michael | Robert | |
| Corpus | (Bagga) | Jones | (Boulder) | Johnson | Smith | Average |
| Bagga | 84.6 | | | | | |
| and | | | | | | |
| Baldwin | | | | | | |
| Chen and | 80.3 | 86.42 | 82.63 | 89.07 | 91.56 | 85.99 |
| Martin | | | | | | |
| Our basic | 78.71 | 87.47 | 80.62 | 87.13 | 89.93 | 84.75 |
| VSM | | | | | | |
| model | | | | | | |

Table 3 lists the complete set of results with breakdown of the contribution of features as they are added into the complete set. Table 3 shows a baseline performance for the Entity Disambiguation System that uses the same set of features as that used by VSM systems. The baseline model uses three separate bag of words model, one for each of Summary 701 terms 702, document entities 705 and base noun phrases 704 and then combines the similarity values using plain average. The difference between the results for the Entity Disambiguation System and those reported by other VSM systems may be due to the difference in the software 309 used, the list of stop words and the Soft TF-IDF weighting scheme used by other VSM systems. The remaining rows of Table 3 show the use of a single bag of words model (all features in the same bag of words) along with the log transformed TF-IDF weighting scheme. It can be observed from Table 3 that the addition of features, fine tunings and the use of log-transformed weighting scheme contribute significantly to improve the performance from the baseline model.

TABLE 3

| | John | James | John | Michael | Robert | |
|---|---|---|---|---|---|---|
| Corpus | Smith (Bagga) | Jones | Smith (Boulder) | Johnson | Smith | Average |
| No Of | 35 | 24 | 54 | 52 | 65 | |
| Clusters | | | | | | |
| Chen and | 92.02 | 97.10 (28) | 91.94 (61) | 92.55 (51) | 93.48 (78) | 93.41 |
| Martin − | | | | | | |
| Optimal | | | | | | |
| Threshold − | | | | | | |
| S + BNP + DE | | | | | | |
| (Separate | | | | | | |
| bag of words + | | | | | | |
| Soft TF- | | | | | | |
| IDF) | | | | | | |
| Chen and | — | 96.64 | 91.31 (dev) | 90.57 (dev) | 86.71 | 93.41 |
| Martin − | | | | | | |
| Fixed Stop | | | | | | |
| Threshold − | | | | | | |
| S + BNP + DE | | | | | | |
| (Separate | | | | | | |
| bag of words + | | | | | | |
| Soft TF- | | | | | | |
| IDF) | | | | | | |
| Baseline − | 84.20 (48) | 98.11 (25) | 85.50 (62) | 90.79 (61) | 90.37 (79) | 89.79 |
| S + BNP + DE | | | | | | |
| (Separate | | | | | | |
| bag of | | | | | | |
| words) | | | | | | |
| Baseline + | 93.96 (42) | 90.54 (33) | 86.80 (71) | 89.52 (67) | 92.66 (73) | 90.69 |
| Log | | | | | | |
| Transformed | | | | | | |
| Model | | | | | | |
| (Single bag | | | | | | |
| of words + | | | | | | |
| Log | | | | | | |
| Transformed | | | | | | |
| Tf-Idf) | | | | | | |
| S + BNP + DE | 92.28 (50) | 95.48 (26) | 89.50 (69) | 91.64 (49) | 92.42 (72) | 92.26 |
| S + BNP + DE + | 91.93 (47) | 98.14 (25) | 91.46 (65) | 90.22 (57) | 92.54 (77) | 92.85 |
| PF (A) | | | | | | |
| A + Nsw | 92.77 (49) | 98.14 (25) | 90.56 (67) | 89.85 (62) | 93.22 (70) | 92.90 |
| A + Nsw + | 92.83 (49) | 98.14 (25) | 91.24 (68) | 93.27 (55) | 94.27 (73) | 93.95 |
| Ptf | | | | | | |
| A + Nsw + | 92.62 (42) | 99.03 (26) | 91.49 (67) | 94.01 (56) | 93.03 (76) | 94.03 |
| Ptf + TM | | | | | | |
| A + Nsw + | | 94.7 (25) | 89.2 (61) (dev) | 89.92 (63) (dev) | 89.80 (67) | |
| Ptf + TM | | | | | | |
| (Fixed Stop | | | | | | |
| Threshold) | | | | | | |

Additionally, as shown in Table 3 above, the Entity Disambiguation System baseline model outperforms (in average F-measure) VSM Systems for both optimal and fixed stop threshold. For the sake of completeness, Table 3 also shows results from learning the separate bag of words model with the Entity Disambiguation System.

In another alternative, the similarities from the individual features are combined or averaged in multiple ways, such as (i) plain average, (ii) neural network weighting and/or (iii) maximum entropy weighting. The lower performance for these justifies the use of a single bag of words model.

In another alternative, the software 309 links content from an open source system, such as wikis, blogs and/or websites to structured information, such as records in an enterprise database management system. The Entity Disambiguation System may be used with mobile devices, such as KINDLE. In one example, the Entity Disambiguation System links contents of the entity profiles 308, such as entities 304 and/or events 307 to electronic documents, on websites, such as WIKIPEDIA or DBPEDIA. In a further example, the Entity Disambiguation System links entities 304, such as characters and/or authors of documents, such as novels, periodicals, articles and or newspapers with electronic documents, on websites, such as WIKIPEDIA or DBPEDIA where these entities 304 may have been mentioned.

Resource Description Framework

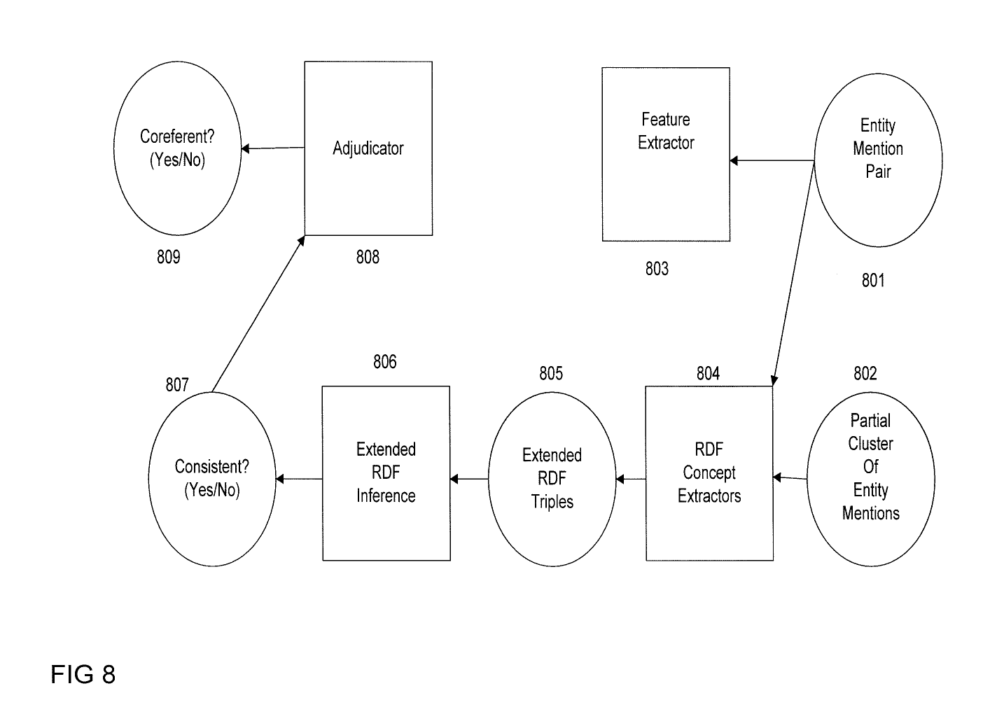

In another embodiment of the Entity Disambiguation System, some leveraging of entities profile 308 features in a document is obtained using the resource description framework (RDF). FIG. 8 shows a flowchart illustrating a series of operations, according to embodiments of the Entity Disambiguation System that may use the extended RDF inference engine to improve pair-wise coreference resolution. At step 801 a set of features are extracted given a particular entity mention pair according to various embodiments of the Entity Disambiguation System. In step 802 a partial cluster of entity mentions 301 is extracted from the Entity profile according to various embodiments of the Entity Disambiguation System. In step 803 the features extracted in step 801 encode either specific characteristics of the entity mention pair or characteristics of the context surrounding the entity mention pair as they exist in the input text. In step 804 the features in step 803, the Entit mention Pair from step 901 and the partial cluster of entity mentions 801 from step 802 are represented as RDF Triples or nodes in a form factor graph. In step 805 the RDF triples of step 804 are extended with inference process. In step 806 the results of the extended RDF inference process from step 805 are used as input to the statistical model, which returns the probability that the pair is actually coreferent in step 807. Finally, at step 808 an adjudicator makes a final decision as to whether the pair is coreferent in step 909 based on this probability.

For example, if two entities 304 (say A and C) are coreferent, and entities 304 B and C are coreferent as well, then, A and B may also be coreferent. This is an example of 2_{nd} order entity relation, where based on the current set of features, it is only through a third entity 304 (C), the relationship 306 between entities A and B become apparent. The MaxEnt, is not sophisticated enough to exploit this useful property inherent in this particular problem. In a further example, if entity pairs A-C 903 had a high probability of coreference, and B-C 904 also had a high probability, then this should have a positive influence on the probability of A-B 902. In one alternative, a more complicated machine learning model such as Conditional Random Field (CRF) may be used to take advantage of this property to enhance the performance.

In some alternatives, CRFs are used with IE problems such as POS-tagging, shallow parsing as well as named entity recognition. CRFs may also be used to exploit the implicit dependency that exists in the problem of coreference resolution

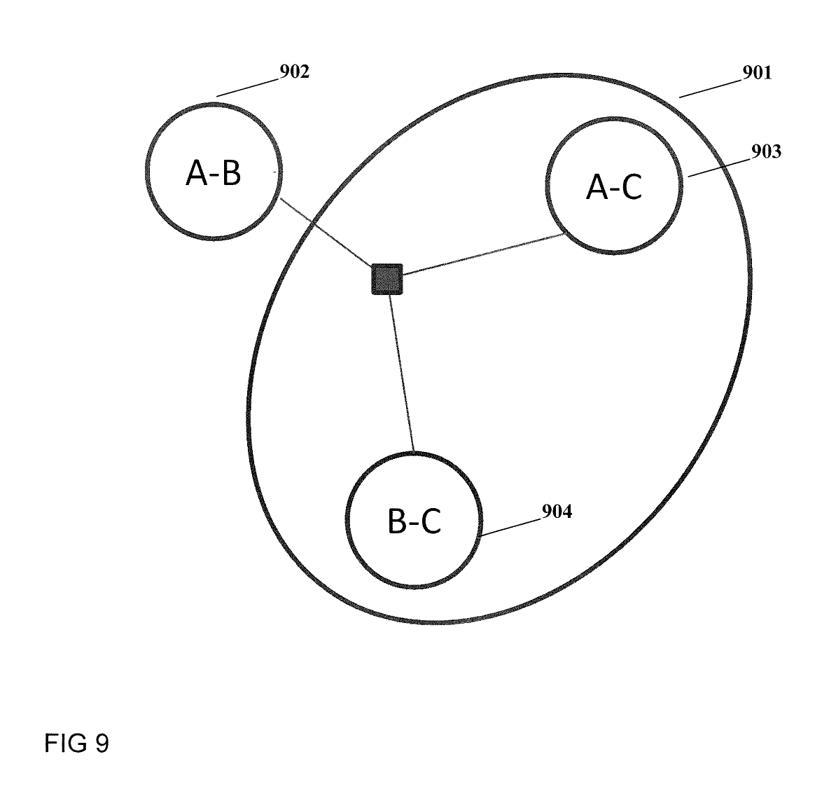

In one alternative, every pair of candidate entities 304, are to be labeled as coreferent (‘yes’—Label=1) or not coreferent (‘No’—Label=0). The Entity Disambiguation System uses a MaxEnt to compute the probability for the pair of candidate entities 304 being coreferent. For the CRF model, the entity pairs are no more independent of each other. Rather, they form a factor graph. Each node in the graph may be an entity pair. The edges connecting the node i to other nodes, corresponds to the neighbors of that node. An example of connection in the factor graph is illustrated in FIG. 9. In the figure, the neighbor for the node A-B 902, may be the clique 901 formed from the nodes A-C 903 and B-C 904 combined together. The criterian for the selection of neighbors 901 is further explained below. Every node is characterized by two elements (i) Label: The label of that node (1 if they are c-referent and 0 if they are not) and (ii) MaxEnt probability: The MaxEnt probability of coreference of the entity pairs in that node. As it can be seen, for training, the first of the two is known, and is used for parameter estimation. For example, the label may be set to 1 if the MaxEnt probability is greater than 0.5 and if not 0. Similar to a node, every clique 901 (a set of two nodes that is a neighbor to a third node), is characterized by the same two elements only defined a little differently (i) Label: The product of the labels of the nodes involved in the clique 901 and (ii) MaxEnt probability: The product of the MaxEnt probabilities of co-reference of the nodes involved in the clique. With the above in mind, the CRF model is very similar to MaxEnt except for an additional term in the exponent for capturing 2_{nd} order entity relationship. The model is given below in the following equation:

$$p ( {y}_{i} = a \vert {y}_{{N}_{i}} , {x}_{i} , θ ) = \frac{{e}^{( {\sum }_{j} {f}_{{j}_{i}}^{s} \cdot {θ}_{aj}^{s} + {\sum }_{k ∈ {N}_{i}} {\sum }_{j} {f}_{{j}_{ik}}^{i} \cdot {θ}_{{j}_{{ay}_{k}}}^{i} )}}{Z}$$

where p(yᵢ=a|y_{N}_{ᵢ}, xᵢ, θ) indicates the probability of the label of the i^{th} entity pair to be a (1 or 0), given the labels of its neighbors(y_{N}_{ᵢ}), the entity pair xᵢ and the parameters of the model θ. fⱼ_{ᵢ}^{s} is the j^{th} state feature computed for the i^{th} node (in our case, there are two features one is the bias set to 1 and the other the MaxEnt probability), fⱼ_{ᵢₖ}^{t} is the j^{th} transition feature (j is 1 or 2) of the k^{th} neighbor (clique) to the i^{th} node. The j^{th} transition feature is simply the j^{th} characteristic element of the clique as defined above. θₐⱼ^{s} is the state parameter corresponding to the j^{th} state feature and the label a. Similarly, [symbol] is the transition parameter corresponding to the j^{th} transition feature, and the label pair a, yₖ (a is the label of the node in question and yₖ is the label of the k^{th} neighbor). Z is the normalization constant and is equal to sum over all a's of the numerator. The number of state parameters |θ^{s}|, is No of state features×No of labels=1×2=2. The number of transition parameters |θ^{t}| is No of transition features×No of Possible label pairs=2×|{1,1},{1,2},{2,2}|=2×3=6. For the CRF, the parameters were estimated by maximizing the pseudo likelihood using conjugate gradient descent.

In some alternatives, ten neighbors are selected for every node. These correspond to the ten cliques 901 which have the highest MaxEnt probability. This probability is actually a product of two probabilities.

For example, given a new pair of candidate entities, the probability of coreference is computed using Gibbs sampling. Firstly, the MaxEnt probability is used to find the initial labels (using threshold probability of 0.5). From this, the labels of all the neighbors (cliques) 901 of all the nodes are computed (A product of the nodes involved in the clique). And now for each node in FIG. 5, the CRF probability may be computed given the labels and MaxEnt probabilities of all its neighbors 901. The nodes are selected at random and probabilities repeatedly computed until convergence.

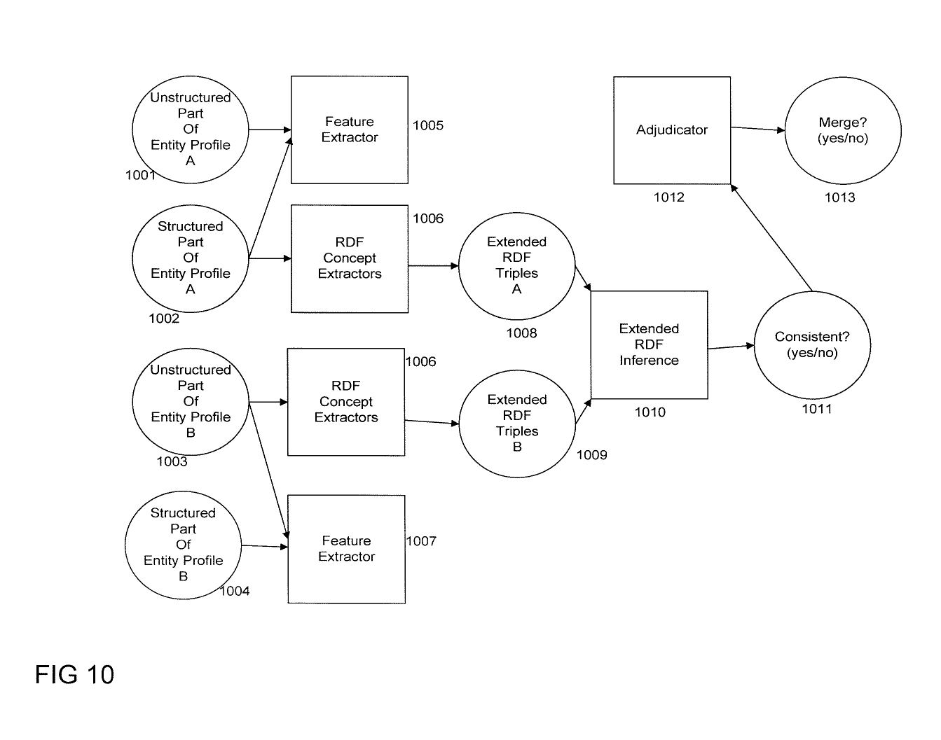

In another alternative, the RDF is used for cross document co-reference resolution as illustrated by FIG. 10. At steps 1001, 1002, 1003 and 1004 a set of features are extracted from the structured and unstructured part of one or more entity profiles 308. In step 1005 and 1007 the features extracted in steps 1001, 1002, 1003 and 1004 encode either specific characteristics of the entity mention pair or characteristics of the context surrounding the entity mention pair as they exist in the input text. In step 1006 the features in step 1005 and 1007 are represented as RDF Triples or nodes in a form factor graph. In steps 1008 and 1009, the RDF triples from step 1006 are extended with inference processes. In step 1009, the results of the extended RDF inference process from 1007 and 1008 are used as input to the statistical model, which returns the probability in step 1011 that the pair is actually coreferent. In step 1012 an adjudicator makes a final decision as to whether the pair is coreferent based on this probability. And finally, in step 1013 the entities are merged based on the results of step 1010 or thresholds, or other criteria established by the user.

Electronic Document Ranking

To find information in related databases a computerized search may be performed. For example, on the World Wide Web, it is often useful to search for web pages of interest to a user. Various techniques may be used including providing key words as the search argument. The key words may often be related by Boolean expressions. Search arguments may be selectively applied to portions of documents such as title, body etc., or domain URL names for example. The searches may take into account date ranges as well. A typical search engine may present the results of the search with a representation of the page found including a title, a portion of text, an image or the address of the page. The results may be typically arranged in a list form at the user's display with some sort of indication of relative relevance of the results. For instance, the most relevant result may be at the top of the list following in decreasing relevance by the other results. Other techniques indicating relevance may include a relevance number, a widget such as a number of stars or the like. The user may often be presented with a link as part of the result such that the user can operate a GUI interface such as a cursor selected display item to navigate to the page of the result item. Other well known techniques include performing a nested search wherein a first search may be performed followed by a search within the records returned from the first search. Today many search engines exist expressly designed to search for web pages via the internet within the World Wide Web. Various techniques may be utilized to improve the user experience by providing relevant search results, including GOOGLE's PAGERANK.

PAGERANK is a link analysis algorithm, used by GOOGLE that assigns a numerical weighting to each element of a hyperlinked set of documents, such as the World Wide Web, with the purpose of “measuring” its relative importance within the set. The algorithm may be applied to any collection of entities with reciprocal quotations and references. GOOGLE may combine the query independent characteristics of the PAGERANK algorithm, and other query dependent algorithms to rank search results generated from queries.

Under a preferred PAGERANK algorithm, a document's (web page) score (weight) may be the sum of the values of its back links (links from other documents). A document having more back links is more valuable than one with less back links.

In another example, a paper is published on the web by a usually popular author. Many publication indices may contain links (hyperlinks) to this paper. However, this paper turned out to contain inaccurate results, and hence, few other papers cite this paper. A search engine based on traditional PAGERANK, such as the GOOGLE search engine, might place this paper at the top of the search results for a search containing key-words in the paper because the paper web page is referenced by many web pages. This may be inaccurate because even though the paper has high total in-degree, few other papers reference it, so this paper may rank low in the opinion of some knowledgeable users.

Conventional systems that rank electronic documents based on PAGERANK are often query-dependent systems. Although, several PAGERANK algorithms may provide query independent ranking, based on the existence of links within electronic documents.

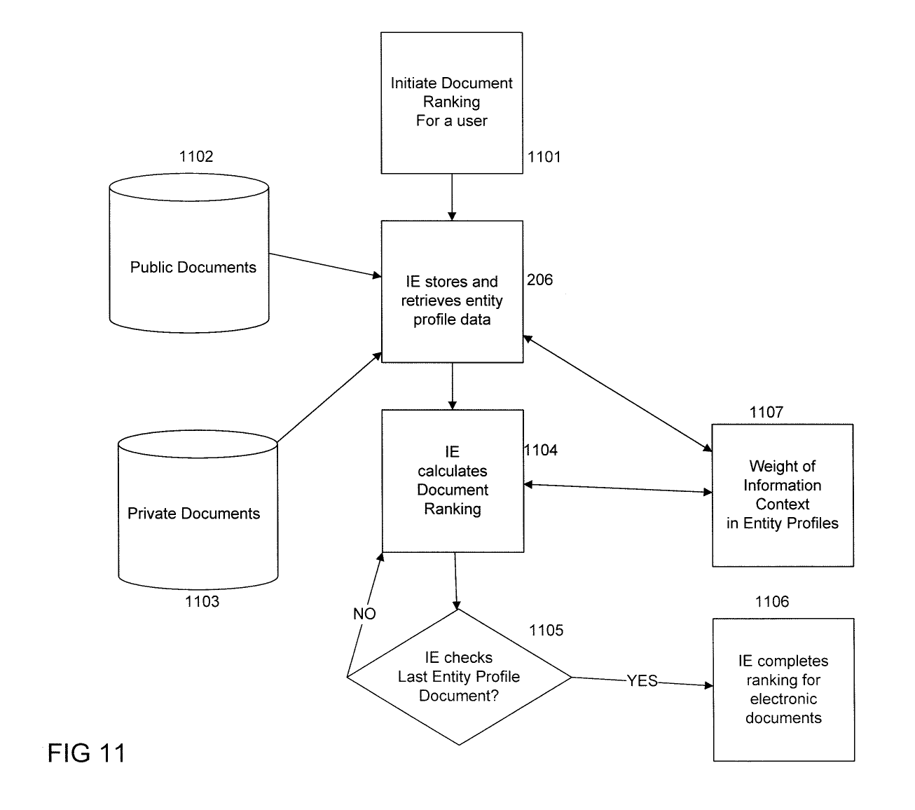

FIG. 11 is a flowchart illustrating a series of operations, according to one embodiment of the Entity Disambiguation System that are used to determine the rank of electronic documents. The process of FIG. 11 is preferably implemented by means of an embodiment of the Entity Disambiguation System such as the software 309 depicted in FIG. 3. At step 1101, a user initiates a query that generates resulting electronic documents, which requires a ranking. In step 206, in response to the query in step 1101, the software 309 retrieves entity profiles 308 from public documents and/or private documents optionally in steps 1102 and/or 1103 according to various embodiments of the Entity Disambiguation System. In step 1104, the software 309 determines the strength 1101 of the one or more entity profiles 308 according to various embodiments of the Entity Disambiguation System. At step 1105, the software 309 determines whether the current document is the last document in the search results. And finally, at step 1107, the software 309 ranks all of the electronic documents in the search results, using the strength 1201 value determined in step 1104.

In one embodiment, the Entity Disambiguation System improves the ranking of electronic document by ranking electronic documents based on their content regardless of the number of hyperlinks to the electronic documents. Alternatively, the Entity Disambiguation System ranks the electronic documents from a search results using a query independent ranking algorithm calculated from the weights of the information context 1201 of an entity profile 308, and ranking the electronic documents based on the strength 1201 of the entity profile 308 as opposed to the number of links to the electronic document. In one alternative, the Entity Disambiguation System may analyze a corpus of electronic documents in which hyperlinks are absent, or where a search query has been executed by a user.

As evidenced by the rapid success of GOOGLE'S search technology, GOOGLE'S PAGERANK is a powerful searching algorithm for ranking public documents that may contain on or more hyperlinks. PAGERANK may, however, find it challenging to rank private documents that may contain a few or no hyperlinks.

In an alternative embodiment, the Entity Disambiguation System provides a heuristic for ranking public documents and private documents, by generating entity profile 308 from these documents, and integrating the information from both domains, using cross-document entity-disambiguation, and using the weights of the information context 1201 in the entity profile 308, to rank these electronic documents. Private documents may comprise document within an enterprise that may contain a few or no hyperlinks. Public documents are documents within an enterprise, or available outside the enterprise from sources, such as the Internet, that may contain one or more hyperlinks to the documents.

In one embodiment, the Entity Disambiguation System is used as a learning ranking algorithm, which can automatically adapt ranking functions to queries, such as web searches that conventionally require a large volume of training data. One or more entity profiles 308 may be generated from click-through data using an IE engine according to various embodiments of the present invention. The Entity disambiguation system may determine a strength value for the one or more entity profiles 308 according to various embodiments of the Entity Disambiguation System. The strength 1201 values are used to ranks all of the electronic documents in a corpus based on thresholds, or other criteria established by the user. Click-through data, is data that represents feedback logged by search engines and contain the queries submitted by the users, followed by the URLS off documents clicked by users for these queries.

In an alternative embodiment, the Entity Disambiguation System is a system for generating heuristics from the strength 1201 of one or more entity profiles 308 to use in the determination of relevant documents. The system assists in the optimization of the search and entity classification of public documents by providing heuristic rules (or rules of thumb) resulting from the extraction of these rules from entity disambiguated documents in a private system. By providing these heuristic rules to an engine that processes public documents, access to the knowledge of how private system documents are classified is provided, without granting access to those private documents. Since the private system documents are more likely to have some level of uniformity concerning the entities profiled, the heuristic rules generated tend to have greater validity.

Semantic Analysis

In another embodiment, the software 309 uses the set of text snippets (or sentences) from an entity profile 308 as the context in which features for sentiment analysis are computed. Sentiment analysis is performed in two phases: (i) the first phase, training, focuses on compiling a lexicon of subjective words and phrases along with their polarities (positive/negative) and an associated weight, and/or (ii) the second phase, sentiment association, a text document collection, is processed and sentiment assigned to entity profile 308 of interest.

For the software 309 to perform sentiment analysis, a lexicon of subjective words/phrases (those with positive or negative polarity associated with them) is first compiled. The following different techniques may be combined to obtain the lexicon.

In one embodiment, the lexicon is compiled by initializing the starting set of subjective words with one or more positive and negative seed adjectives, for example Positive—good, nice, excellent, positive, fortunate, correct, superior and Negative—bad, nasty, poor, negative, unfortunate, wrong, inferior. Using one or more word senses (in WordNet) of the above seed words, the lexicon was expanded by recursive search for synonyms. Synonyms of positive polarity words are marked as positive and vice versa. The sign of the expression

$$\frac{d ( t , bad ) - d ( t , good )}{… d ( good , bad )}$$

may be used to deduce the true polarity of a term t. d(t₁,t₂) may be the number of hops required to reach the term t₂ from t₁ in the WordNet graph using synonyms.

In another embodiment, if only synonyms are used as the starting set of words, the total list of words obtained may be only 4280. Using synonyms and antonyms may increase the lexicon to 6276. Here, the positive and negative seed words may be expanded independently and later the common words occurring on both sides may be resolved for polarity. The expression

$$\frac{1}{{c}^{d}} ,$$

where c may be a constant >1 and d may be the depth of the recursion, may be used to assign a score to a term.

In another embodiment, one or more words from WordNet that may have a familiarity count of >0 may be used. Using the synonym distance to words, such as “good” and “bad,” their polarity may be found as above. For those words, which may not have been linked to words, such as “good” and “bad” (polarity is 0), alternate way of finding their polarity may be using co-occurrence of terms in the ALTAVISTA search engine. The expression

$${ln}_{2} ( \frac{hits ( phrases … NEAR … {}_{}^{``}{good}{}_{}^{″} ) hits ( {}_{}^{``}{bad}{}_{}^{″} )}{hits ( phrases … NEAR … {}_{}^{``}{bad}{}_{}^{″} ) hits ( {}_{}^{``}{good}{}_{}^{″} )} )$$

may be used to calculate the polarity of words using the ALTAVISTA search engine where the NEAR operator was relaxed to include the entire document. Hits may be the number of relevant documents for the given query.

The lexicon may be further expanded by inserting “not” (negation) before the word/phrases. The corresponding polarity weights are also inverted.

Sentiment Association

In one embodiment, if L={ [symbol] w₁, p₁ [symbol] , [symbol] w₂, p₂ [symbol] , . . . , [symbol] wₙ, pₙ [symbol] } is the complete list of words/phrases with polarity information (positive/negative weights), where wᵢ . . . {1, . . . , N} is the word/phrase and its corresponding polarity weight is pᵢ. The compiled lexicon may contain trigrams, bigrams and unigrams. For example, the steps below are used to associate sentiment information with entities 304.

First, one or more sentences in which the entity 304 that may be the focus of the analysis or its coreference is mentioned within a given context, such as a document or chapter of a book, may be extracted.

Second, a sliding window of one or more n-grams (starting with trigrams and then bigrams and unigrams) may pick up phrases from the summary sentence and matches it up against the compiled lexicon.

Third, if p is be the sum of all positive polarity weights of those one or more n-grams for which a match may be found in the lexicon, and N be the corresponding sum of all negative polarity weights. If T₁, and T_{N} may be the total number of matching one or more n-grams for positive and negative polarity word/phrases in the lexicon, the expression for the probability of positive sentiment polarity for a given entity may be given as

$$P ( Positive ) = \frac{p}{p + N} .$$

If P(Positive) is between 0.6 and 1, a positive polarity label may be assigned.

Forth, if P(Positive) is between 0 and 0.4, a negative polarity label may be assigned. A neutral polarity may be assigned for other values.

Fifth, the final probabilities may be calculated using the threshold (0.6 and 0.4). For example, if P(Positive) is 0.9, then the final probability of positive polarity is

$$\frac{0.9 - 0.6}{1.0 - 0.6} = 0.75 .$$

Similarly if P(Positive) is 0.2, then the final probability of negative polarity is

$$\frac{0.4 - 0.2}{0.4 - 0.0} = 0.5 .$$

Sixth, the confidence of association of the polarity is obtained using

$$\frac{{T}_{p}}{{T}_{p} + {T}_{N}} or \frac{{T}_{N}}{{T}_{p} + {T}_{N}} ,$$

corresponding to whether a positive or negative sentiment may have been associated.

In one example, Sentiment analysis was applied to characters in the novel, Mansfield Park by Jane Austen. Specifically, it was applied to the character Mary Crawford at different times within the novel. The experiments selected the character of Mary Crawford because she may have been the subject of much literary debate. There may be many who believe that Mary Crawford may be an anti-heroine and indeed, perhaps an alter ego for the author herself. In any case, she may be a somewhat controversial character and therefore interesting to analyze. The text of Mansfield Park, originally consisting of 159,500 words, was split into multiple parts based on chapter breaks. Two types of analysis were performed, which are described below.

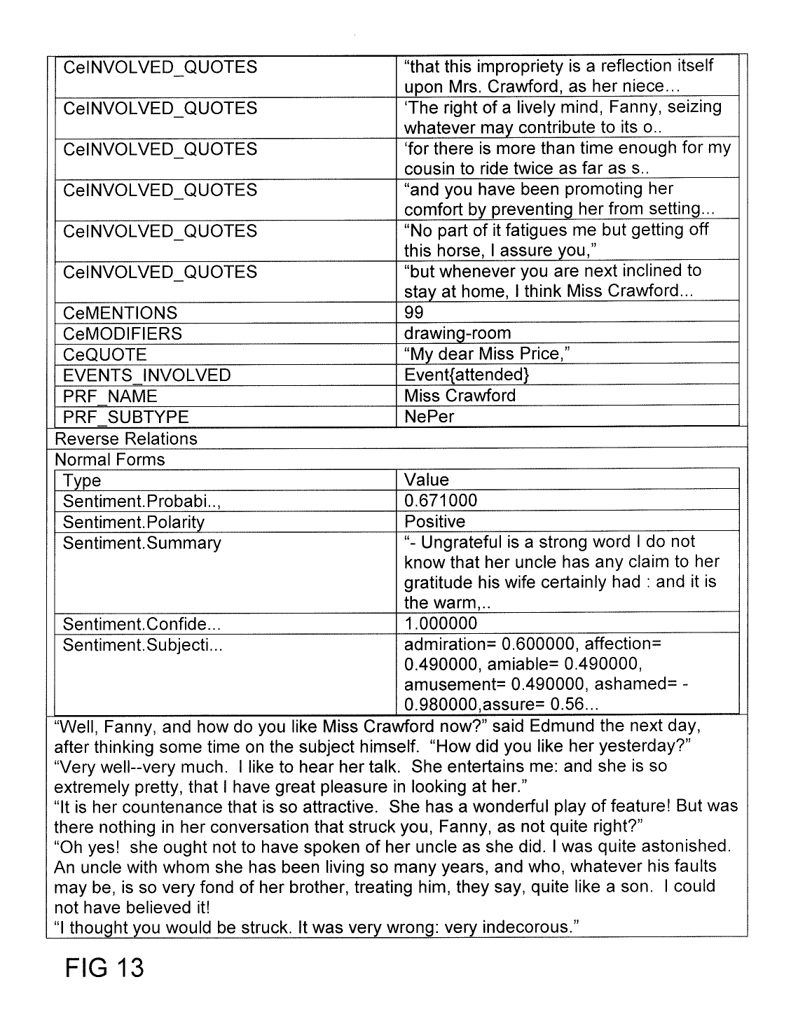

FIG. 13 illustrates a portion of the entity profile extracted for the character of Mary Crawford in chapter 7 of Mansfield Park according to various embodiments of the Entity Disambiguation System.

### Experiment 1

### Reader Perception of Mary Crawford Throughout the Novel

This experiment focuses on how the character of Mary Crawford over the course of the novel, Mansfield Park, by Jane Austen, was perceived by the reader. Furthermore, the experiment was interested in observing how this perception changed over the course of the novel, specifically, chapter by chapter. Entity profile 308 were generated for Mary Crawford at the end of each chapter (non-cumulative) and was based on one or more of the following criteria:
one or more mentions of an entity (i) Named mentions: Mary Crawford, Miss Crawford, (ii) Nominal mentions: his sister, dear girl, and (iii) Pronouns: she, herself;
one or more descriptions or Modifiers of an entity, for example “poor Mary”, “too much vexed;”
relations 306 to other Entities 304 in the text, for example Sibling_of: Mrs. Grant, Located_in: London;
one or more events 307 the Entity 304 may be a participant in (usually subject or object role) e.g., “Miss Crawford accepted the part very readily;”
one or more quotes attributed to the Entity 304, for example “Every generation has its improvements,” said Miss Crawford, with a smile, to Edmund;
one or more quotes involving or about that Entity 304, for example ‘Maria blushed in spite of herself as she answered, “I take the part which Lady Ravenshaw was to have done, and” (with a bolder eye) “Miss Crawford is to be Amelia.”

The results from this experiment are summarized below in Table 4. The values for the perception of Mary Crawford in Table 4 were computed from sentiment analysis on the profiles of Mary Crawford at the end of each chapter. In most chapters, Mary Crawford has a fairly high positive rating whereas the experiment anticipated a more conservative rating through most of the book. This was attributed to the generally polite language used by her and all characters. In the sentiment lexicon, certain words that are more polite are sprinkled liberally and have high positive values, for example

| | | |
|---|---|---|
| dearest | 0.57704544 | 24 mentions |
| pleased | 0.6 | 38 mentions |
| pleasing | 0.49 | 15 mentions |

The various dips in Mary's overall sentiment may be most interesting as these correlate well with events 307 in the text. Some of the interesting correlations include: Chapter 9—Mary finds out that Edmund is destined for the Clergy, and reacts with surprise and judgment. Chapter 10—Mary and Edmund leave Fanny alone in the garden at Southerton and are the subjects of abuse by other characters. Chapter 29—Edmund leaves Mansfield to take orders and Mary is anxious for their shared future and in a bad temper. Chapter 38—Fanny has gone home to her parents; the only reflections about Mary are by Fanny, and not mitigated by other characters more sympathetic to her. For example, “she [Fanny] trusted that Miss Crawford would have no motive for writing strong enough to overcome the trouble.” Chapter 43—Mary writes a letter to Fanny, teasing about Henry and hinting about Edmund, neither of which may be appreciated.

TABLE 4

| | | Mary |
|---|---|---|
| Chapter | Polarity | Sentiment |
| 1 | | — |
| 2 | | — |
| 3 | | — |
| 4 | 0.684 | positive |
| 5 | 0.684 | positive |
| 6 | 0.667 | positive |
| 7 | 0.671 | positive |
| 8 | 0.684 | positive |
| 9 | 0.708 | positive |
| 10 | −0.678 | negative |
| 11 | 0.69 | positive |
| 12 | 0.855 | positive |
| 13 | | — |
| 14 | 0.0446 | neutral |
| 15 | 0.0494 | neutral |
| 16 | 0.0769 | neutral |
| 17 | 0.847 | positive |
| 18 | 0.873 | positive |
| 19 | 1 | positive |
| 20 | | — |
| 21 | 0.759 | positive |
| 22 | 0.353 | neutral |
| 23 | 0.03 | neutral |
| 24 | 0.712 | positive |
| 25 | 0.767 | positive |
| 26 | 0.799 | positive |
| 27 | 0.645 | positive |
| 28 | 0.734 | positive |
| 29 | −0.622 | negative |
| 30 | 0.674 | positive |
| 31 | 0.658 | positive |
| 32 | | — |
| 33 | | — |
| 34 | 0.877 | positive |
| 35 | 0.665 | positive |
| 36 | 0.626 | positive |
| 37 | 0.0529 | Neutral |
| 38 | −0.681 | negative |
| 39 | | — |
| 40 | 0.797 | positive |
| 41 | 0.721 | positive |
| 42 | 0.028 | neutral |
| 43 | −0.785 | negative |
| 44 | 0.054 | neutral |
| 45 | 0.797 | positive |
| 46 | −0.633 | negative |
| 47 | 0.003 | Neutral |
| 48 | 0.804 | positive |

### Experiment 2

### Mary Crawford as Perceived by Other Characters

This experiment focuses on Mary Crawford, but this time as she was perceived by Fanny and Edmund, the main characters in the novel Mansfield Park, by Jane Austen. The experiment restricted the analysis to the last ten chapters of the novel, because these are the chapters where there is general consensus that the opinions of Fanny and Edmund with respect to Mary Crawford undergo much fluctuation. To perform these experiments, the software 309 was reconfigured to include the correct context. In this case, two entity profiles 307 were generated for Mary Crawford per chapter, one reflecting the context needed to assess sentiment through the perspective of Fanny, and the other of Edmund. The context in each of these entity profiles 307 included:
direct quotes attributed to either Fanny or Edmund: These were derived by selecting those quotes in Mary's profile that were about her and attributed to either Fanny or Edmund. For example, in chapter 44 (Edmund's perspective): ‘My Dear Fanny . . . to give up Mary Crawford would be to give up the society of some of those most dear to me.’
Letters written by Fanny or Edmund that spoke of Mary Crawford.
Character narrative, where the thoughts of a character are relayed through the narrator for example, in chapter 46 (Fanny's perspective): “As Fanny could not doubt . . . from her knowledge of Miss Crawford's temper.”
If Mary Crawford's name was not explicitly mentioned in any of the resulting text above, the pronominal mention 301 were replaced with her name for clarification.

The opinions of Mary Crawford by the characters Fanny and Edmund in the final ten chapters of the novel, Mansfield Park, by Jane Austen are summarized below in Table 5. Fanny's opinion of Mary Crawford which has always been rather tenuous plunges dramatically during chapters 42 through 46. Edmund on the other hand has been besotted by Mary Crawford and even though his opinion of her may be lowered in the last few chapters, it may not be as much of a drop as Fanny's. These observations may be consistent with the plot of the novel.

TABLE 5

| Chapter | Fanny | Edmund |
|---|---|---|
| 38 | 0.627 | 1 |
| 39 | | |
| 40 | 0.842 | |
| 41 | | |
| 42 | 0.007 | |
| 43 | −0.73 | |
| 44 | −0.721 | 0.064 |
| 45 | ?? | |
| 46 | −0.643 | |
| 47 | | 0.095 |
| 48 | | 0.0291 |

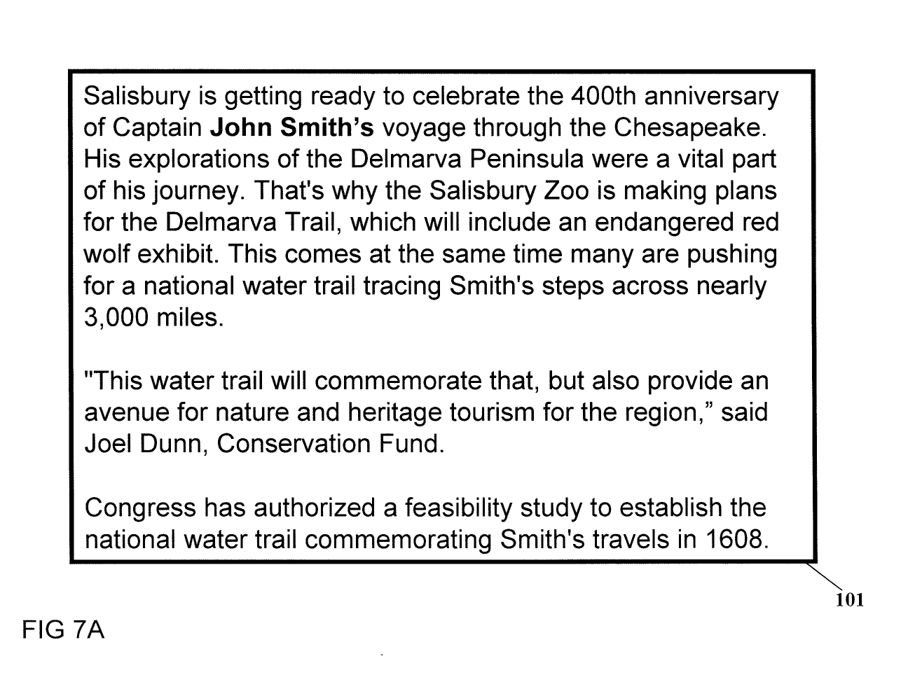

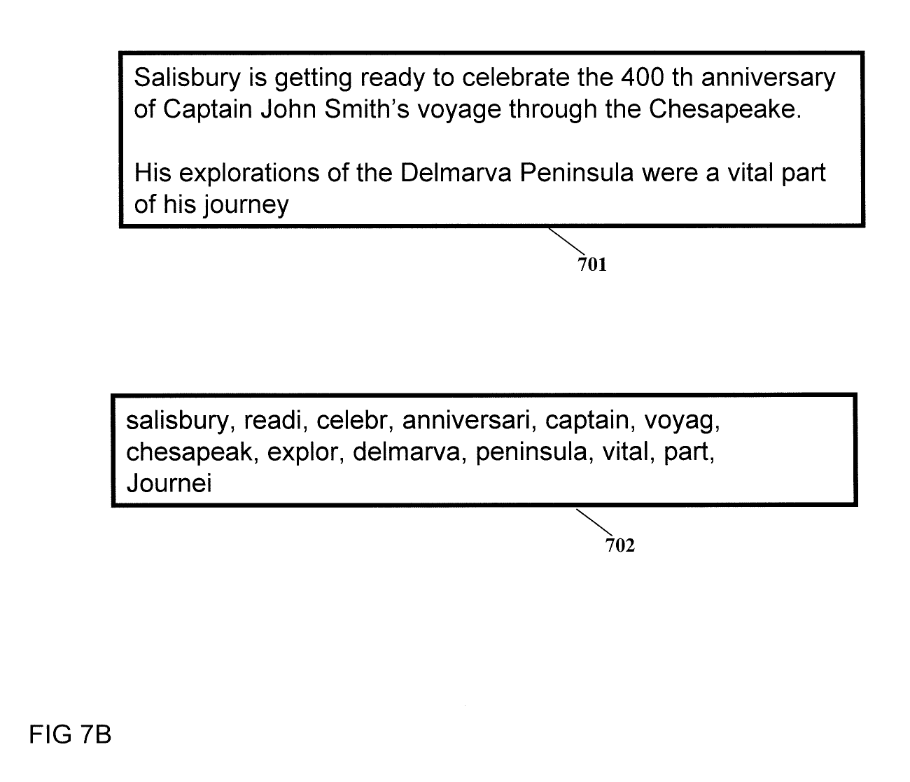

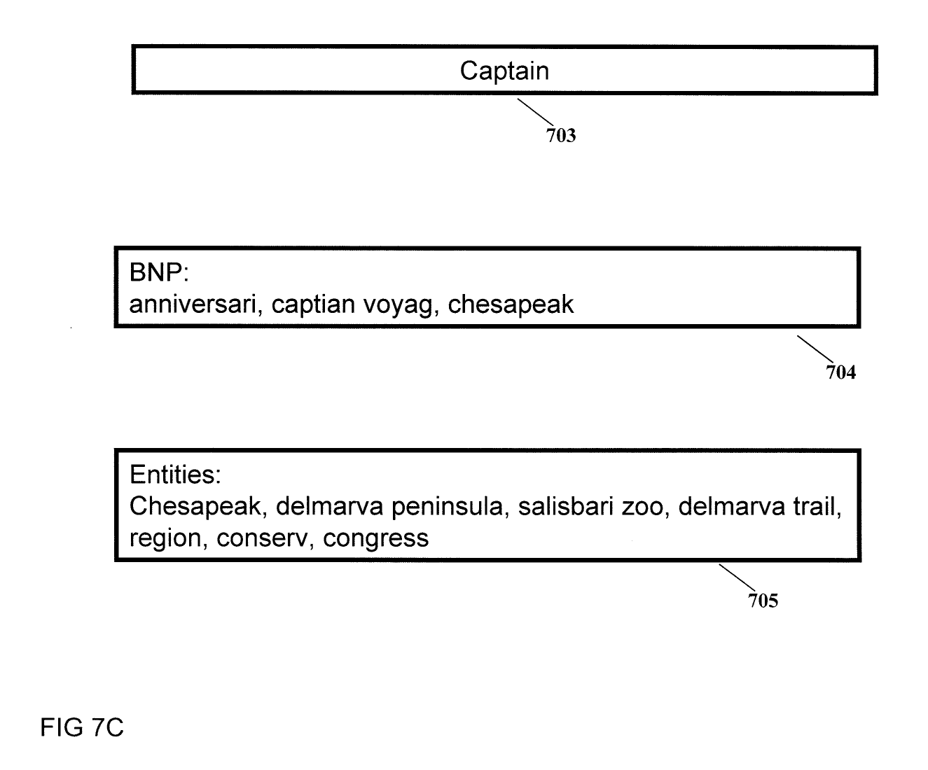

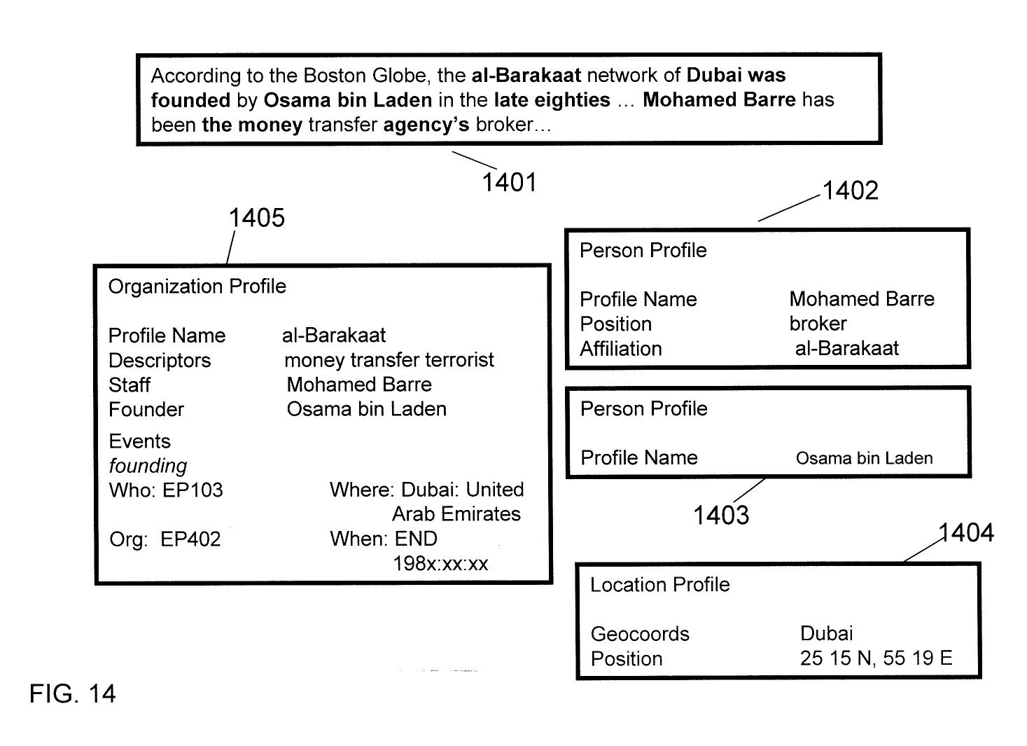

The flowcharts, illustrations, and block diagrams of FIGS. 1 through 14 illustrate the architecture, functionality, and operation of possible implementations of systems and methods according to various embodiments of the Entity Disambiguation System. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the Entity Disambiguation System and, although specific terms are employed, they are used in a generic and descriptive sense only and not for purposes of limitation, the scope of the Entity Disambiguation System being set forth in the following claims. Similarly, while specific equations and algorithms are set forth supra, one of skill in the art would immediate envisage that other equations and algorithms that comprise those set forth are also contemplated are considered part of embodiments of the Entity Disambiguation System.

Although the foregoing description is directed to the preferred embodiments of the Entity Disambiguation System, it is noted that other variations and modifications will be apparent to those skilled in the art, and may be made without departing from the spirit or scope of the Entity Disambiguation System. Moreover, features described in connection with one embodiment of the Entity Disambiguation System may be used in conjunction with other embodiments, even if not explicitly stated above.

1. A system for detecting similarities between entities in a plurality of electronic documents comprising:
instructions for executing a method stored in a storage medium and executed by at least one processor comprising:
extracting data for the at least two entities from the plurality of electronic documents, wherein the at least two entities comprise a first entity and a second entity;
generating at least one entity profile with a plurality of features for the first entity;
generating at least one entity with a plurality of features for the second entity;
representing the plurality of features of the first entity as a plurality of vectors in a vector space model;
representing the plurality of features of the second entity as a plurality of vectors in a vector space model;
determining weights for each of the features the first entity and the second entity, said weights calculated from a term frequency-inverse document frequency value with a cosine similarity Log-transformed measure by an equation comprising the following algorithm:
$$Sim ( {S}_{1} , {S}_{2} ) = {\sum }_{{commontermst}_{j}} {w}_{1 j} \times {w}_{2 j} , \\ where {w}_{ij} = \frac{ln ( tf \times ln \frac{N}{df} )}{\sqrt{{s}_{i 1}^{2} + {s}_{i 2}^{2} + … + {s}_{in}^{2}}}$$
where
S₁ and S₂ are vectors for the first entity and the second entity for which the weights are to be calculated;
tⱼ is the first entity or the second entity,
tf is the frequency of the first entity or the second entity tⱼ in the vector,
N is the total number of the plurality of electronic documents,
df is the number of the plurality of electronic documents that the first entity or the second entity tⱼ occurs in,
denominator is the cosine normalization;
determining a final similarity value from the weights; and
combining the entities into clusters based on the final similarity value.

2. The system of claim 1, in which the at least two entities are selected from a group consisting of a person, place, event, location, expression, concept and combinations thereof.

3. The system of claim 1, in which the plurality of features of the first entity and the plurality of features of the second entity comprise summary terms, base noun phrases and document entities.

4. The system of claim 1, wherein the at least one entity profiles comprise features of an entity, relations, and events that the entity is involved in as a participant in the plurality of electronic documents.

5. The system of claim 1, wherein the vector space model comprises a separate bag of words model for a feature in the at least one entity profile.

6. The system of claim 5, wherein the single bag of words comprises morphological features appended to the single bag of words model.

7. The system of claim 6, in which the morphological features are selected from a group consisting of topic model features, name as a stop word, and prefix matched term frequency and combinations thereof.

8. The system of claim 7, wherein the topic model features comprises selecting ten top words, wherein said top ten words have a joint probability that is the highest as compared to other ten word combinations.

9. The system of claim 1, wherein determining a final similarity value comprises averaging the weights for the plurality of features of the first entity and the plurality of features of the second entity.

10. The system of claim 9, in which the average is selected from a group consisting of plain average, neural network weighting or maximum entropy weighting and combinations thereof.

11. A computer based method for detecting similarities between entities in a plurality of electronic documents, said methods comprising the following steps:
extracting data for the at least two entities from the plurality of electronic documents, wherein the at least two entities comprise a first entity and a second entity;
generating at least one entity profile with a plurality of features for the first entity;
generating at least one entity with a plurality of features for the second entity;
representing the plurality of features of the first entity as a plurality of vectors in a vector space model;
representing the plurality of features of the second entity as a plurality of vectors in a vector space model;
determining weights for each of the features the first entity and the second entity, said weights calculated from a term frequency-inverse document frequency value with a cosine similarity Log-transformed measure by an equation comprising the following algorithm:
$$Sim ( {S}_{1} , {S}_{2} ) = {\sum }_{{commontermst}_{j}} {w}_{1 j} \times {w}_{2 j} , \\ where {w}_{ij} = \frac{ln ( tf \times ln \frac{N}{df} )}{\sqrt{{s}_{i 1}^{2} + {s}_{i 2}^{2} + … + {s}_{in}^{2}}}$$
where
S₁ and S₂ are vectors for the first entity and the second entity for which the weights are to be calculated;
tⱼ is the first entity or the second entity,
tf is the frequency of the first entity or the second entity tⱼ in the vector,
N is the total number of the plurality of electronic documents,
df is the number of the plurality of electronic documents that the first entity or the second entity tⱼ occurs in,
denominator is the cosine normalization;
determining a final similarity value from the weights; and
combining the entities into clusters based on the final similarity value.

12. The method of claim 11, wherein the vector space model comprises a separate bag of words model for a feature in the at least one entity profile.

13. The method of claim 12, wherein the single bag of words comprises morphological features appended to the single bag of words model.

14. The method of claim 13, in which the morphological features are selected from a group consisting of topic model features, name as a stop word, and prefix matched term frequency and combinations thereof.

15. The method of claim 14, wherein the topic model features comprises selecting ten top words, wherein said top ten words have a joint probability that is the highest as compared to other ten word combinations.

16. The method of claim 11, wherein determining a final similarity value comprises averaging the weights for the plurality of features of the first entity and the plurality of features of the second entity.

17. The method of claim 16, in which the average is selected from a group consisting of plain average, neural network weighting or maximum entropy weighting and combinations thereof.

18. A system for detecting similarities between entities in a plurality of electronic documents comprising:
instructions for executing a method stored in a storage medium and executed by at least one processor comprising:
extracting data for the at least two entities from the plurality of electronic documents, wherein the at least two entities comprise a first entity and a second entity;
generating at least one entity profile with a plurality of features for the first entity;
generating at least one entity with a plurality of features for the second entity;
representing the first entity as a node on a form factor graph;
representing the second entity as a node on a form factor graph;
selecting cliques for the first entity node and the second entity node;
determining the probability of coreference between the first entity and the cliques;
combining the entities into clusters based on the probability of coreference.

19. The system of claim 18, wherein the form factor graph is a resource description framework graph.

20. The system of claim 18, wherein selecting cliques comprise selection of ten neighbors for the first entity node and the second entity node which have the highest MaxEnt probability values as compared to other neighbors.

21. The system of claim 20, wherein one of the ten neighbors for the first entity node comprises the second entity node.

22. The system of claim 20, wherein one of the ten neighbors for the second entity node comprises the first entity node.

23. The system of claim 18, wherein the probability of coreference is calculated with a conditional random field model.

24. A computer based method for detecting similarities between entities in a plurality of electronic documents, said methods comprising the following steps:
extracting data for the at least two entities from the plurality of electronic documents, wherein the at least two entities comprise a first entity and a second entity;
generating at least one entity profile with a plurality of features for the first entity;
generating at least one entity with a plurality of features for the second entity;
representing the first entity as a node on a form factor graph;
representing the second entity as a node on a form factor graph;
selecting cliques for the first entity node and the second entity node;
determining probability of coreference between the first entity and the cliques;
combining the entities into clusters based on the probability of coreference.

25. The method of claim 24, wherein selecting cliques comprise selection of ten neighbors for the first entity node and the second entity node which have the highest MaxEnt probability values as compared to other neighbors.

26. A system for ranking a plurality of electronic documents comprising:
instructions for executing a method stored in a storage medium and executed by at least one processor comprising:
generating at least one entity profile for an entity with a plurality of features from the extracted data;
representing the at least one entity profile as a plurality of vectors in a vector space model;
determining weights for the at least one entity profile, said weights calculated by a calculated from a term frequency-inverse document frequency value with a cosine similarity Log-transformed measure; and
ranking the electronic documents based on the weights.

27. The system of claim 26, wherein the vector space model comprises a separate bag of words model for a feature in the at least one entity profile.

28. The system of claim 27, wherein the single bag of words comprises morphological features appended to the single bag of words model.

29. The system of claim 28, in which the morphological features are selected from a group consisting of topic model features, name as a stop word, and prefix matched term frequency and combinations thereof.

30. The system of claim 29, wherein the topic model features comprises selecting ten top words, wherein said top ten words have a joint probability that is the highest as compared to other ten word combinations.

31. The system of claim 26, wherein in the electronic documents comprise web sites, search engines, news feeds, blogs, transcribed audio, legacy text corpuses, surveys, database records, e-mails, translated text (FBIS), technical documents, transcribed audio, classified HUMINT documents, USMTF, XML, other structured or unstructured data from commercial content providers and combinations thereof.

32. The system of claim 31, wherein the plurality of languages comprises English, Chinese, Arabic, Urdu, and Russian and combinations thereof.

33. A computer based method for ranking electronic documents, said methods comprising the following steps:
generating at least one entity profile for an entity with a plurality of features from the extracted data;
representing the at least one entity profile as a plurality of vectors in a vector space model;
determining weights for the at least one entity profile, said weights calculated by a calculated from a term frequency-inverse document frequency value with a cosine similarity Log-transformed measure; and
ranking the electronic documents based on the weights.

34. The method of claim 33, wherein the vector space model comprises a separate bag of words model for a feature in the at least one entity profile.

35. The method of claim 33, wherein the single bag of words comprises morphological features appended to the single bag of words model.

36. The method of claim 35, in which the morphological features are selected from a group consisting of topic model features, name as a stop word, and prefix matched term frequency and combinations thereof.

37. The method of claim 36, wherein the topic model features comprises selecting ten top words, wherein said top ten words have a joint probability that is the highest as compared to other ten word combinations.
